(19) United States
(12) Patent Application Publication
(10) Pub. No.: US 2025/0062507 A1
(43) Pub. Date: Feb. 20, 2025

(54) SECONDARY BATTERY

(71) Applicant: MURATA MANUFACTURING CO., LTD., Kyoto (JP)

(72) Inventor: Kenta EGUCHI, Kyoto (JP)

(21) Appl. No.: 18/937,396

(22) Filed: Nov. 5, 2024

Related U.S. Application Data
(63) Continuation of application No. PCT/JP2023/026519, filed on Jul. 20, 2023.

(30) Foreign Application Priority Data
Aug. 29, 2022 (JP) 2022-135934

(51) Int. Cl. H01M 50/559; H01M 10/0525; H01M 50/109; H01M 50/181; H01M 50/184; H01M 50/188; H01M 50/342; H01M 50/55; H01M 50/564

(52) U.S. Cl. CPC H01M 50/559; H01M 10/0525; H01M 50/109; H01M 50/181; H01M 50/184; H01M 50/188; H01M 50/342; H01M 50/55; H01M 50/564; H01M 2200/20

(57) ABSTRACT

Provided is a secondary battery including: an electrode assembly; an outer case accommodating the electrode assembly; and an electrode terminal disposed on the outer case, the electrode terminal being electrically connected to the electrode assembly via a conductive member. In such a secondary battery, the electrode terminal and the outer case are adhered to each other by an insulating seal member interposed between the electrode terminal and the outer case and provided around an opening of the outer case through which the conductive member passes, and a plan view outline of the electrode terminal on a surface of the electrode terminal in contact with the insulating seal member includes both a linear portion and a curved portion, a plan view outline of the outer case on a surface of the outer case in contact with the insulating seal member includes a curve, and the curved portion of the electrode terminal and a part of the curve of the outer case face each other.

### CROSS REFERENCE TO RELATED APPLICATIONS

The present application is a continuation of PCT patent application no. PCT/JP2023/026519, filed on Jul. 20, 2023, which claims priority to Japanese patent application no. 2022-135934, filed on Aug. 29, 2022, the entire contents of which are incorporated herein by reference.

### BACKGROUND

The present disclosure relates to a secondary battery.

Secondary batteries are so-called storage batteries and therefore can be repeatedly charged and discharged, and the secondary batteries are used in various applications. For example, secondary batteries are used in mobile devices such as mobile phones, smart phones, and notebook computers.

### SUMMARY

The present disclosure relates to a secondary battery. More specifically, the present disclosure relates to a secondary battery including an electrode assembly including an electrode-constituting layer including a positive electrode, a negative electrode, and a separator.

A secondary battery includes an electrode assembly having electrode-constituting layers laminated therein, the electrode-constituting layers including a positive electrode, a negative electrode, and a separator disposed therebetween, and an outer case configured to enclose the electrode assembly. In such a secondary battery, it is conceivable to provide a cleavage mechanism on the assumption of, for example, a case in which an in-cell pressure increases. This is to prevent a more serious accident such as an unintended battery explosion.

On the other hand, it is necessary to provide an external terminal provided for electrical connection with the outside for use of the secondary battery.

For example, there is room for development in the battery configuration that satisfies both the cleavage mechanism and the installation of the terminal.

The present disclosure relates to providing, in an embodiment, a new battery configuration from the viewpoint of a cleavage mechanism and terminal installation.

A secondary battery according to the present disclosure is provided.

The secondary battery, in an embodiment, includes:
an electrode assembly;
an outer case accommodating the electrode assembly; and
an electrode terminal disposed on the outer case, the electrode terminal being electrically connected to the electrode assembly via a conductive member,
in which the electrode terminal and the outer case are adhered to each other by an insulating seal member interposed between the electrode terminal and the outer case and provided around an opening of the outer case through which the conductive member passes, and
a plan view outline of the electrode terminal on a surface of the electrode terminal in contact with the insulating seal member includes both a linear portion and a curved portion, a plan view outline of the outer case on a surface of the outer case in contact with the insulating seal member includes a curve, and the curved portion of the electrode terminal and a part of the curve of the outer case face each other.

The secondary battery according to the present disclosure has a previously unknown battery configuration in which both terminal installation and a cleavage mechanism are involved, and it is easier to provide an external lead-out member for external connection, and to provide a more suitable cleavage mechanism according to an embodiment. More specifically, when a plan view outline of the electrode terminal includes both the linear portion and the curved portion, a ratio of a plan view area of a non-terminal region on the battery main surface can be easily secured as compared with a case where such a configuration of an outline of the electrode terminal is not included according to an embodiment. Therefore, the external lead-out member is easily provided in the non-terminal region, and the secondary battery of the present disclosure is easily provided as a more suitable battery according to an embodiment. In addition, when a pressing force is generated due to an abnormal increase in the internal pressure of the outer case or the like, the electrode terminal can be cleaved so as to open in order to prevent an unintended battery explosion in advance, but in the secondary battery of the present disclosure, such cleavage is relatively likely to occur from the “linear portion” according to an embodiment. That is, the electrode terminal is easily cleaved so as to be opened from the linear portion in the plan view outline of the electrode terminal, and the predictability when the in-cell pressure abnormally increases can be improved according to an embodiment.

### BRIEF DESCRIPTION OF THE FIGURES

FIG. 1 includes views (A) and (B) that are sectional views, schematically showing an electrode-constituting layer. FIG. 1, view (A) is a planar stacked structure; and FIG. 1, view (B) is a wound structure.

FIG. 2 is a perspective view schematically showing an external appearance of a secondary battery according to an embodiment of the present disclosure.

FIG. 3 includes views (A) and (B) that are schematic diagrams of the secondary battery according to the embodiment of the present disclosure. FIG. 3, view (A) is a sectional view; and FIG. 3, view (B) is a half-divided perspective view.

FIG. 4 is a schematic diagram showing representative elements constituting the secondary battery according to an embodiment of the present disclosure.

FIG. 5 includes views (A) to (D) that are schematic diagrams each showing a plan view of a main surface of the secondary battery according to an embodiment of the present disclosure.

FIG. 6 includes views (A) to (D) that are schematic diagrams each showing a plan view outline of an electrode terminal according to an embodiment of the present disclosure together with a plan view outline of an outer case.

FIG. 7 includes views (A) to (D) that are schematic diagrams each showing a plan view outline of the electrode terminal according to an embodiment of the present disclosure.

FIG. 8 is a schematic diagram showing a plan view outline of the electrode terminal according to the embodiment of the present disclosure.

FIG. 9 includes views (A) to (D) that are schematic diagrams each showing a plan view outline of the outer case according to an embodiment of the present disclosure.

FIG. 10 is a schematic diagram showing a configuration related to an outer case opening of the secondary battery according to an embodiment of the present disclosure.

FIG. 11 is a schematic diagram for explaining a vent mechanism related to the present disclosure.

FIG. 12 includes views (A) to (D) that are schematic diagrams each showing a plan view outline of an insulating seal member according to an embodiment of the present disclosure.

FIG. 13 is a schematic diagram for explaining deflection or strain of the outer case when an in-cell pressure abnormally increases.

FIG. 14 includes views (A) and (B) that are schematic perspective views for explaining an “installation mode of external lead-out member”.

FIG. 15 includes views (A) and (B) that are schematic diagrams for explaining a virtual battery as a base assumed in EXAMPLES.

FIG. 16, view (A) is a schematic diagram in which configurations of an example and a comparative example are modeled, and FIG. 16, view (B) is a schematic diagram showing an area of a non-terminal region related to a modeled configuration.

FIG. 17 is a graph showing simulation result.

### DETAILED DESCRIPTION

Hereinafter, a secondary battery according to an embodiment of the present disclosure will be described in more detail. Although the description will be made with reference to the drawings as necessary, various elements in the drawings are only schematically and exemplarily illustrated for understanding of the present disclosure, and the appearances and/or the dimensional ratios may be different from actual ones. The secondary battery described below is for embodying the technical idea of the present disclosure, and unless otherwise specified, the present disclosure is not limited to the following. For the sake of easier explanation or understanding, the description may be separately given for embodiments and examples, but the structures shown in separate embodiments and the like may be partly replaced or combined. In the description of such an embodiment, descriptions of matters common to those described above may be omitted, and only different points may be described. In particular, similar functions and effects made by similar configurations are sometimes not be sequentially mentioned for each embodiment.

The “sectional view” described directly or indirectly in the present specification is based on a virtual section obtained by cutting the secondary battery along the stacking direction of the electrode assembly or the electrode-constituting layer constituting the secondary battery. The direction of the “thickness” described directly or indirectly in the present specification is based on the stacking direction of the electrode materials constituting the secondary battery, the direction along a winding axis of the stacking structure that is wound, and the like. For example, in the case of a “secondary battery that has a thickness in a plate shape” such as a button type or a coin type, the direction of the “thickness” may correspond to the plate thickness direction of the secondary battery. Furthermore, a “plan view” can correspond to, for example, a view obtained when an object is viewed in a normal direction or a perpendicular direction of a main surface (for example, an upper surface) of the object.

The terms “up-down direction” and “left-right direction” directly or indirectly used in the present specification respectively correspond to the up-down direction and the left-right direction in the drawing. Unless otherwise specified, the same reference symbols or signs indicate the same members or portions or the same semantic contents. According to a preferred aspect, it can be understood that the downward direction in the vertical direction (that is, the direction in which gravity acts) corresponds to a “downward direction”, whereas the opposite direction corresponds to an “upward direction”.

The various numerical ranges mentioned in the present specification are intended to include the lower and upper limit numerical values themselves unless otherwise specified. Note that the terms “approximately”, “degree”, and “constant” mean that they may include variations or differences of a few percent, for example, ±10%.

In the present description, the term “secondary battery” refers to a battery that can be repeatedly charged and discharged. Accordingly, the secondary battery according to the present disclosure is not excessively limited by its name, and for example, an electric storage device and the like can also be included in the subject of the present disclosure.

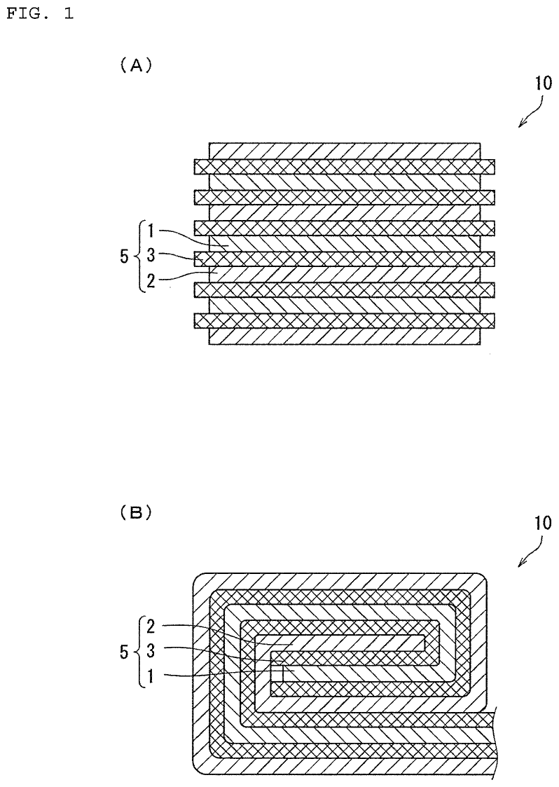

The secondary battery according to the present disclosure includes an electrode assembly in which an electrode-constituting layer including a positive electrode, a negative electrode and a separator is stacked. FIGS. 1(A) and 1(B) illustrate an electrode assembly 10. As illustrated in the drawings, a positive electrode 1 and a negative electrode 2 are laminated with a separator 3 interposed therebetween to form an electrode-constituting layer 5, and at least one or more of the electrode-constituting layers 5 are laminated to form the electrode assembly 10. FIG. 1(A) has a planar laminated structure in which the electrode-constituting layers 5 are laminated in a planar shape without being wound. On the other hand, FIG. 1(B) has a wound laminated structure in which the electrode-constituting layer 5 is wound in a wound shape. That is, in FIG. 1(B), the electrode-constituting layer 5 including the positive electrode 1, the negative electrode 2, and the separator 3 disposed between the positive electrode 1 and the negative electrode 2 has a wound structure in which the electrode-constituting layer 5 is wound in a roll shape. In the secondary battery, such an electrode assembly is enclosed in an outer case together with an electrolyte (for example, a non-aqueous electrolyte). The structure of the electrode assembly is not necessarily limited to the planar laminated structure or the wound structure. For example, the electrode assembly may have a so-called stacked-and-folded type structure in which the positive electrode, the separator, and the negative electrode are laminated on a long film and then folded.

The positive electrode is formed of at least a positive electrode material layer and a positive electrode current collector. In the positive electrode, the positive electrode material layer is provided on at least one surface of the positive electrode current collector. The positive electrode material layer contains a positive electrode active material as an electrode active material. For example, in each of the plurality of positive electrodes in the electrode assembly, the positive electrode material layer may be provided on both surfaces of the positive electrode current collector, or the positive electrode material layer may be provided only on one surface of the positive electrode current collector.

The negative electrode is formed of at least a negative electrode material layer and a negative electrode current collector. In the negative electrode, the negative electrode material layer is provided on at least one surface of the negative electrode current collector. The negative electrode material layer contains a negative electrode active material as an electrode active material. For example, in each of the plurality of negative electrodes in the electrode assembly, the negative electrode material layer may be provided on both surfaces of the negative electrode current collector, or the negative electrode material layer may be provided only on one surface of the negative electrode current collector.

The electrode active materials contained in the positive electrode and the negative electrode, that is, the positive electrode active material and the negative electrode active material are materials directly involved in the transfer of electrons in the secondary battery, and are main materials of the positive and negative electrodes responsible for charging and discharging, that is, a battery reaction. More specifically, ions are brought into the electrolyte due to the “positive electrode active material contained in the positive electrode material layer” and the “negative electrode active material contained in the negative electrode material layer”, and the ions move between the positive electrode and the negative electrode to transfer electrons, and thus charging and discharging is performed. The positive electrode material layer and the negative electrode material layer may be layers particularly capable of occluding and releasing lithium ions. That is, the secondary battery according to the present disclosure may be a nonaqueous electrolyte secondary battery in which lithium ions move between the positive electrode and the negative electrode through a nonaqueous electrolyte, whereby charging and discharging of the battery is performed. When lithium ions are involved in charging and discharging, the secondary battery according to the present disclosure corresponds to a so-called “lithium ion battery”, and the secondary battery includes layers capable of occluding and releasing lithium ions as the positive electrode and the negative electrode.

The positive electrode active material of the positive electrode material layer is formed of, for example, a granular material, and a binder may be contained in the positive electrode material layer for more sufficient contact between particles and shape retention. Furthermore, the positive electrode material layer may contain a conductive auxiliary in order to facilitate electron transfer promoting the battery reaction. Similarly, while the negative electrode active material of the negative electrode material layer is formed of, for example, a granular material, a binder may be contained for more sufficient contact between particles and shape retention, and a conductive auxiliary agent may be contained in the negative electrode material layer in order to facilitate the transfer of electrons promoting a battery reaction. As described above, since a plurality of components are contained, the positive electrode material layer and the negative electrode material layer can also be referred to as a “positive electrode mixture layer” and a “negative electrode mixture layer”, respectively.

The positive electrode active material may be a material that contributes to occlusion and release of lithium ions. From such a viewpoint, the positive electrode active material may be, for example, a lithium-containing composite oxide. More specifically, the positive electrode active material may be a lithium-transition metal composite oxide containing lithium and at least one transition metal selected from the group consisting of cobalt, nickel, manganese, and iron. That is, the positive electrode material layer of the secondary battery according to the present disclosure preferably contains such a lithium-transition metal composite oxide as the positive electrode active material. For example, the positive electrode active material may be lithium cobalt oxide, lithium nickel oxide, lithium manganese oxide, lithium iron phosphate, or a material obtained by replacing the transition metal in a positive electrode active material described above with another metal. Such positive electrode active materials may be included as a single species, or two or more species thereof may be included in combination.

The binder that can be contained in the positive electrode material layer is not particularly limited, and examples of the binder include at least one selected from the group consisting of polyvinylidene fluoride, vinylidene fluoride-hexafluoropropylene copolymers, vinylidene fluoride-tetrafluoroethylene copolymers, polytetrafluoroethylene, and the like. The conductive auxiliary agent that can be contained in the positive electrode material layer is not particularly limited, and examples of the conductive auxiliary agent include at least one selected from the group consisting of carbon black such as thermal black, furnace black, channel black, ketjen black, and acetylene black, carbon fibers such as graphite, carbon nanotubes, and vapor-grown carbon fibers, metal powders such as copper, nickel, aluminum, and silver, polyphenylene derivatives, and the like.

A thickness dimension of the positive electrode material layer is not particularly limited, but may be 1 μm or more and 300 μm or less, and is, for example, 5 μm or more and 200 μm or less. The thickness dimension of the positive electrode material layer is a thickness inside the secondary battery, and an average value of measured values at any 10 points may be adopted.

The negative electrode active material may be a material that contributes to occlusion and release of lithium ions. From such a viewpoint, the negative electrode active material may be, for example, various carbon materials, oxides, and/or lithium alloys.

Examples of the various carbon materials for the negative electrode active material can include graphite (natural graphite and/or artificial graphite), hard carbon, soft carbon, and/or diamond-like carbon. Examples of the oxides for the negative electrode active material include at least one selected from the group consisting of silicon oxide, tin oxide, indium oxide, zinc oxide, and lithium oxide. The lithium alloy for the negative electrode active material may be any metal that can be alloyed with lithium, and may be, for example, a binary, ternary, or higher alloy of lithium and a metal such as Al, Si, Pb, Sn, In, Bi, Ag, Ba, Ca, Hg, Pd, Pt, Te, Zn, or La.

The binder that can be contained in the negative electrode material layer is not particularly limited, and examples of the binder include at least one selected from the group consisting of styrene-butadiene rubber, polyacrylic acid, polyvinylidene fluoride, polyimide-based resins, and polyamideimide-based resins. The conductive auxiliary agent that can be contained in the negative electrode material layer is not particularly limited, and examples of the conductive auxiliary agent include at least one selected from the group consisting of carbon black such as thermal black, furnace black, channel black, ketjen black, and acetylene black, carbon fibers such as graphite, carbon nanotubes, and vapor-grown carbon fibers, metal powders such as copper, nickel, aluminum, and silver, polyphenylene derivatives, and the like. Note that the negative electrode material layer may contain a component derived from a thickener component (for example, a carboxymethyl cellulose) used at the time of manufacturing the battery.

A thickness dimension of the negative electrode material layer is not particularly limited, but may be 1 μm or more and 300 μm or less, and is, for example, 5 μm or more and 200 μm or less. The thickness dimension of the negative electrode material layer is a thickness inside the secondary battery, and an average value of measured values at any 10 points may be adopted.

The positive electrode current collector and the negative electrode current collector used for the positive electrode and the negative electrode are members configured to contribute to collecting and supplying electrons generated in the electrode active material due to the battery reaction. Such an electrode current collector may be a sheet-like metal member. Furthermore, the electrode current collector may have a porous or perforated form. For example, the current collector may be a metal foil, a punching metal, a net, an expanded metal, or the like. The positive electrode current collector used in the positive electrode preferably includes a metal foil containing at least one selected from the group consisting of aluminum, stainless steel, nickel, and the like, and may be, for example, an aluminum foil. On the other hand, the negative electrode current collector used for the negative electrode is preferably made of a metal foil containing at least one selected from the group consisting of copper, stainless steel, nickel, and the like, and may be, for example, a copper foil.

A thickness dimension of each of the positive electrode current collector and the negative electrode current collector is not particularly limited, but may be 1 μm or more and 100 μm or less, and is, for example, 10 μm or more and 70 μm or less. The thickness dimension of each of the positive electrode current collector and the negative electrode current collector is a thickness inside the secondary battery, and an average value of measured values at any 10 points may be adopted.

The separator used in the positive electrode and the negative electrode is a member provided mainly from the viewpoint of preventing a short circuit due to contact between the positive electrode and the negative electrode and maintaining the electrolyte. In other words, the separator can be considered as a member that allows ions to pass through while preventing electronic contact between the positive electrode and the negative electrode. For example, the separator is a porous or microporous insulating member, and has a membrane form due to its small thickness. As a mere example, a microporous membrane made of polyolefin may be used as the separator. In this regard, the microporous membrane used as the separator may contain, for example, only polyethylene (PE) or only polypropylene (PP) as polyolefin. Furthermore, the separator may be a laminate including a “microporous membrane made of PE” and a “microporous membrane made of PP”. The surface of the separator may be covered with an inorganic particle coating layer and/or an adhesive layer and the like. The surface of the separator may have adhesiveness. In the present disclosure, the separator is not to be particularly limited by its name, and may be solid electrolytes, gel electrolytes, and/or insulating inorganic particles having a similar function.

A thickness dimension of the separator is not particularly limited, but may be 1 μm or more and 100 μm or less, and is, for example, 2 μm or more and 20 μm or less. The thickness dimension of the separator is a thickness inside the secondary battery (particularly, a thickness between the positive electrode and the negative electrode), and an average value of measured values at any 10 points may be adopted.

In the secondary battery of the present disclosure, the electrode assembly including the electrode-constituting layer including the positive electrode, the negative electrode, and the separator may be enclosed in the outer case together with an electrolyte. The electrolyte may be a “non-aqueous” electrolyte containing an organic electrolyte, an organic solvent, and the like, or may be an “aqueous” electrolyte containing water. When the positive electrode and the negative electrode have a layer capable of occluding and releasing lithium ions, the secondary battery preferably contains a “non-aqueous” electrolyte. That is, the electrolyte is preferably a non-aqueous electrolyte. In the electrolyte, metal ions released from the electrodes (the positive electrode and/or the negative electrode) are present, and therefore the electrolyte can assist movement of metal ions in the battery reaction. The electrolyte may have a form such as a liquid form or a gel form.

The non-aqueous electrolyte is an electrolyte containing a solvent and a solute. The solvent may be an organic solvent. A specific organic solvent of the non-aqueous electrolyte may contain at least a carbonate. The carbonate may be a cyclic carbonate and/or a chain carbonate. Although not particularly limited, examples of the cyclic carbonate include at least one selected from the group consisting of propylene carbonate (PC), ethylene carbonate (EC), butylene carbonate (BC), and vinylene carbonate (VC). Examples of the chain carbonate include at least one selected from the group consisting of dimethyl carbonate (DMC), diethyl carbonate (DEC), ethyl methyl carbonate (EMC), and dipropyl carbonate (DPC). Although merely an example, a combination of a cyclic carbonate and a chain carbonate may be used as the non-aqueous electrolyte, and for example, a mixture of an ethylene carbonate and a diethyl carbonate may be used. As a specific solute of the non-aqueous electrolyte, for example, a Li salt such as LiPF₆ and/or LiBF₄ may be used.

The outer case of the secondary battery is a member configured to enclose the electrode assembly having the electrode-constituting layers laminated therein, in which the electrode assembly includes the positive electrode, the negative electrode, and the separator. As will be described later, the outer case may be a metal outer case having a non-laminated configuration.

The secondary battery of the present disclosure has at least a feature in a configuration to which an opening of an outer case enclosing an electrode assembly is related. In particular, the electrode terminal provided so as to cover the opening of the outer case and the battery cleavage mechanism related to the electrode terminal are characterized.

In the secondary battery of the present disclosure, the electrode terminal (positive electrode terminal or negative electrode terminal) disposed on the outer case using the insulating seal member is electrically connected to the electrode assembly via the conductive member. The insulating seal member is interposed between the electrode terminal and the outer case, and is provided around the opening of the outer case through which the conductive member passes. The electrode terminal and the outer case are adhered to each other by the insulating seal member provided around the outer case opening. It can be said that the electrode terminal is preferably adhered to the insulating seal member, and the outer case is also preferably adhered to the insulating seal member. In other words, the opening through which the conductive member passes is provided for the outer case, and the electrode terminal is provided on the outer case surface corresponding to a peripheral region of the opening (on the outer surface of the outer case) so as to cover the opening using an adhesive force of the insulating seal member. Preferably, the electrode terminal is provided on the outer case only by an adhesive force of the insulating seal member regardless of a mechanical or structural action such as caulking (in short, the electrode terminal is provided for the outer case preferably without the electrode terminal, the outer case, and/or the like being caulked).

In the present disclosure, the electrode terminal related to the battery cleavage mechanism has not been previously found. In particular, the outline of the electrode terminal has a unique shape different from a conventional shape in plan view. Specifically, a plan view outline of the electrode terminal includes both a linear portion and a curved portion.

More specifically, in the electrode terminal, the plan view outline of the electrode terminal on the surface in contact with the insulating seal member includes both the linear portion and the curved portion. In the outer case, a plan view outline of the outer case on the surface in contact with the insulating seal member includes a curve. In such a secondary battery of the present disclosure, the curved portion of the electrode terminal and a part of the curve of the outer case face each other.

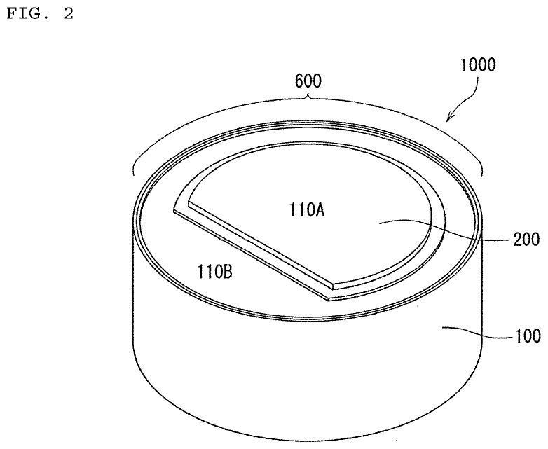

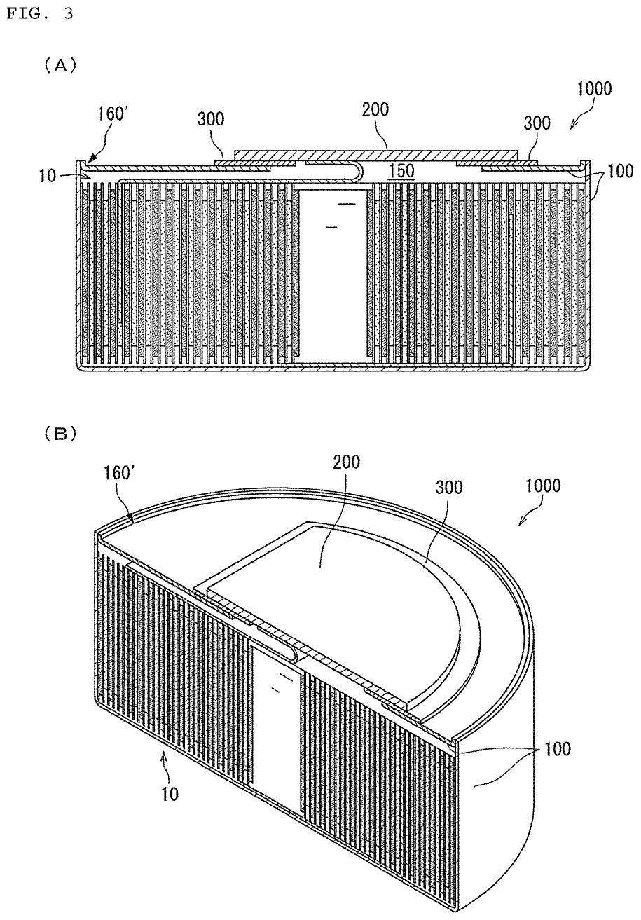

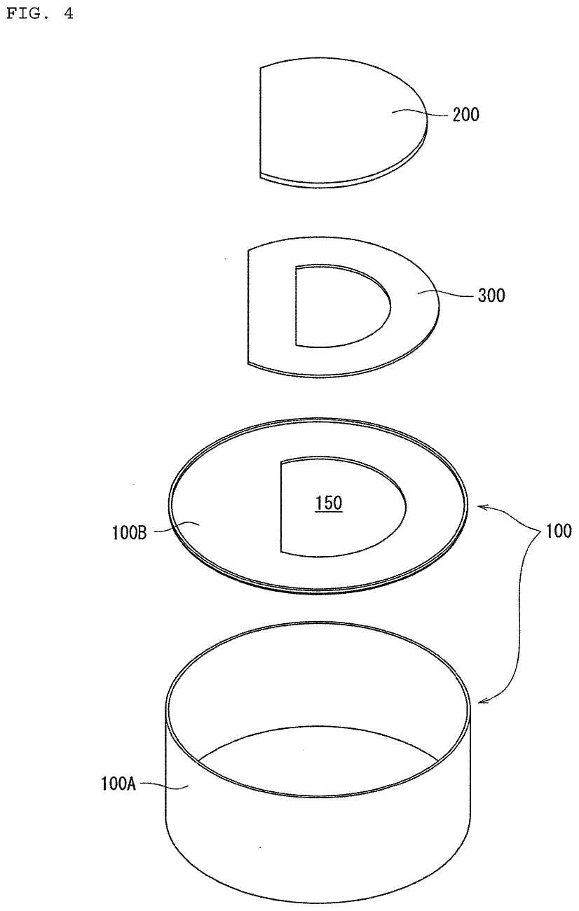

FIG. 2 shows an appearance of a secondary battery 1000 according to the embodiment of the present disclosure, and FIGS. 3(A) and 3(B) show the secondary battery 1000 according to the embodiment of the present disclosure in a sectional view and a half-divided perspective view. In addition, in order to facilitate understanding of the present disclosure, FIG. 4 separately illustrates elements related to the features of the secondary battery of the present disclosure.

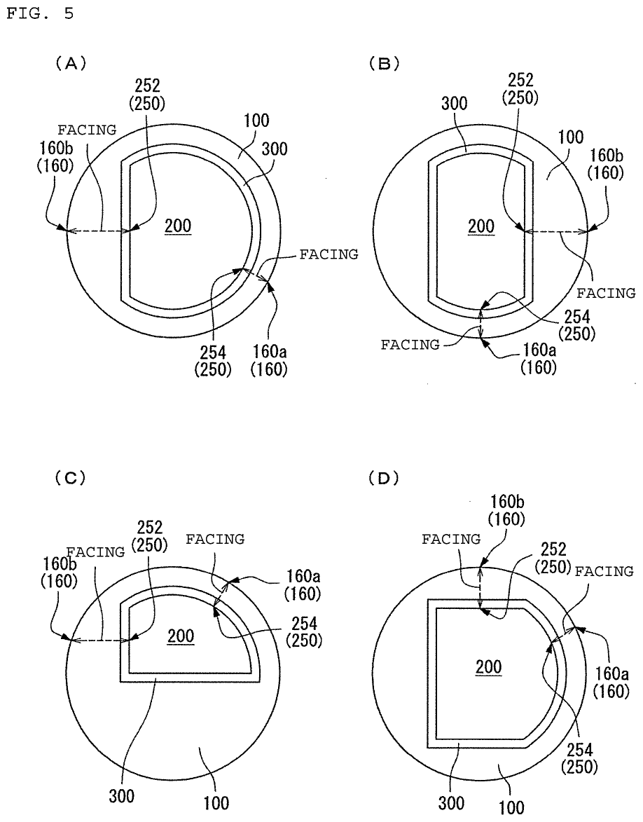

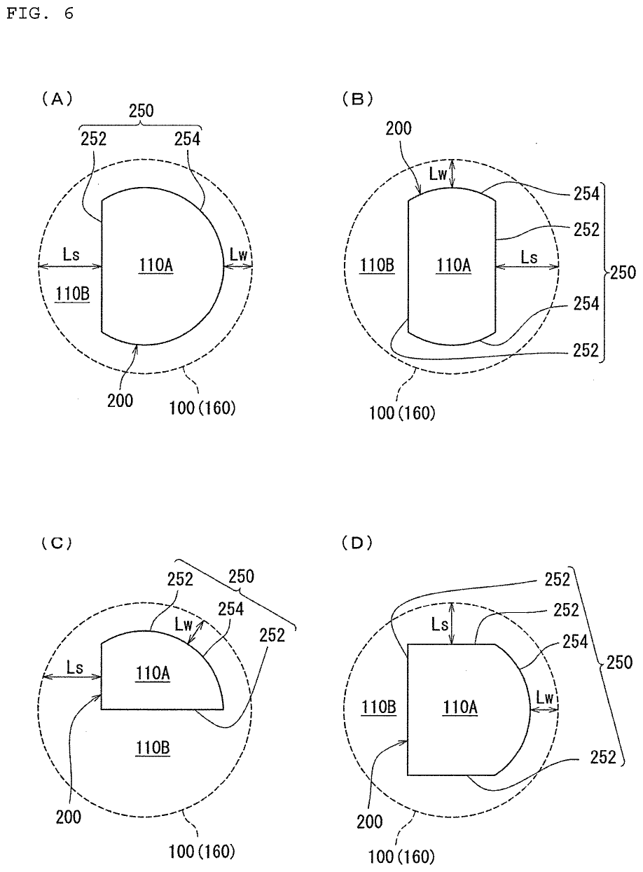

FIGS. 5(A) to 5(D) show plan views of an upper surface side (an installation side of the electrode terminal) of the secondary battery, and particularly show plan view outlines of the electrode terminal and the outer case. FIGS. 6(A) to 6(D) illustrate plan view outlines of the electrode terminals respectively corresponding to FIGS. 5(A) to 5(D). FIGS. 5(A) and 6(A) show plan view outlines corresponding to FIGS. 2 to 4, and FIGS. 5(B) to 5(D) and FIGS. 6(B) to 6(D) show plan view outlines of the secondary battery according to another preferable aspect.

As shown in FIGS. 5(A) to 5(D) and FIGS. 6(A) to 6(D), a plan view outline 250 of an electrode terminal 200 in which the secondary battery is viewed from outside includes two types of a linear portion 252 and a curved portion 254 as a unique shape. That is, in the electrode terminal, the plan view outline of the surface where the electrode terminal is in contact with the insulating seal member includes both the linear portion and the curved portion (hereinafter, such an external outline or outer edge outline of the electrode terminal on the surface in contact with the insulating seal member is also referred to as a “plan view outline of the electrode terminal” or simply an “outline of the electrode terminal”).

In addition, as shown in FIGS. 5(A) to 5(D), a plan view outline 160 of the outer case 100 in which the main surface of the secondary battery is viewed from outside is preferably curved. That is, in the outer case 100, the plan view outline 160 (in particular, the outer edge outline forming the outer edge of the battery) on the surface where the outer case is in contact with an insulating seal member 300 includes a curve. For example, the plan view outline 160 of the outer case 100 on the surface directly in contact with the insulating seal member 300 provided for installation of the electrode terminal 200 includes the curve (hereinafter, such an external outline or an outer edge outline of the outer case when the outer case is viewed as a whole from outside is also referred to as a “plan view outline of the outer case” or simply an “outline of the outer case”). In a preferred aspect, the plan view outline 160 of the outer case 100 is curved as a whole, and for example, all of the plan view outline of the outer case is curved. The plan view outline 160 of the outer case 100 may be circular, for example.

In the secondary battery of the present disclosure, the curvature of the outline of the outer case opposes the curved portion of the electrode terminal in plan view, and preferably directly opposes the curved portion. That is, for example, as shown in FIGS. 5(A) to 5(D), the curved portion 254 in the plan view outline 250 of the electrode terminal 200 and a portion 160a of the curved portion in the plan view outline 160 of the outer case 100 face each other (preferably, directly face each other). It can also be said that the curved portion in the outline of the electrode terminal 200 and a part of the curve in the outline of the outer case 100 face each other or oppose in plan view when the secondary battery is viewed from outside. The term “facing each other” as used herein means that the curved portion of the electrode terminal and the curve of the outer case have a positional relationship in which the curved portion of the electrode terminal and the curve of the outer case are adjacent to or aligned with each other in the plan view outline of the secondary battery (for example, a positional relationship in which the secondary batteries are adjacent to each other or arranged side by side while being separated from each other in a battery plan view when the secondary batteries are viewed from outside), and preferably means that they have a positional relationship in which the curved portion of the electrode terminal and the curve of the outer case are adjacent to or aligned with each other more proximally or directly.

In the secondary battery of the present disclosure, the electrode terminal corresponds to an output terminal provided for external connection. In particular, the electrode terminal is provided on the main surface of the outer case so as to cover the opening portion provided in the main surface, and the electrode terminal is preferably adhered or attached to the main surface of the outer case with the insulating seal member provided around the opening portion being interposed therebetween. The electrode terminal 200 has, for example, a flat plate form (see FIGS. 3 and 4). In other words, the electrode terminal 200 may be a flat plate member (for example, the electrode terminal 200 may have flat planar main surfaces facing each other). The plate-shaped electrode terminal may be, for example, a metal disk. Because of the flat plate shape, the electrode terminal may have a substantially constant thickness.

The electrode terminal is electrically connected to the conductive member of the electrode assembly. The conductive member may be a member containing metal (for example, in short, the metal member), and preferably may be a metal member having an elongated shape. For example, the conductive member may include an electrode current collector of the electrode assembly, or may be a current collecting lead provided in the electrode assembly (in particular, in its electrode). When the conductive member is made of the electrode current collector, the conductive member may be made of a metal portion of the electrode current collector where the electrode material is not provided. When the conductive member is formed of a current collecting lead, the conductive member may be formed of a metal member having a thin form and/or a long form. In the present disclosure, the conductive member electrically connecting the electrode assembly and the electrode terminal to each other can also be referred to as a “tab”. The conductive member preferably has flexibility, and may be provided in a deflected form and/or a bent form in order to contribute to the cleavage mechanism later described.

In the present disclosure, only one electrode terminal may be provided for the battery. That is, as shown in FIGS. 2 and 3, a single electrode terminal 200 may be provided for one battery main surface. In the case of the single electrode terminal, for example, as shown in FIGS. 6(A) to 6(D), a closed region formed by the plan view outline 250 of the electrode terminal may also be single. That is, as shown in plan views of FIGS. 6(A) to 6(D), a single closed region of the plan view outline 250 of the electrode terminal is formed inside the closed region formed by the plan view outline of the outer case (in particular, the plan view outline 160 of the outer case forming the outer edge of the outer case). The material of the electrode terminal 200 is not particularly limited as long as it has electrical conductivity. The electrode terminal may be made of a metal material generally used as a terminal material of the secondary battery. The electrode terminal may contain at least one metal selected from the group consisting of iron, SUS, aluminum, nickel, and copper.

In the present specification, the “plan view outline of the electrode terminal” refers to the outline of the electrode terminal viewed in plan view (for example, an outline of a terminal shape obtained when the electrode terminal is viewed along a normal direction or a perpendicular direction of the main surface of the electrode terminal). Preferably, the outer edge outline of the surface in direct contact with the insulating seal member provided for installation of the electrode terminal among surfaces constituting the electrode terminal (for example, an electrode terminal surface flush with the contact surface) may be regarded as a “plan view outline of the electrode terminal”. In short, the “plan view outline of the electrode terminal” can correspond to an outline shape formed by the outer edge (preferably the outermost edge) of the electrode terminal. Similarly, the “plan view outline of the outer case” refers to the plan view outline of the outer case as described above, and typically refers to an outer edge outline or the external outline of the outer case. Preferably, an outline, an outer outline, or an outer edge outline (preferably, an outline that can be positioned outside the outline of the electrode terminal, or an outer outline or an outer edge outline in plan view) on a surface that is in direct contact with the insulating seal member provided for installation of the electrode terminal among surfaces constituting the outer case (for example, an outer case surface which is flush with the contact surface) may be regarded as an “plan view outline of the outer case”. In a preferred aspect, the “plan view outline of the outer case” in the present disclosure may be regarded as an outline of the outer case when the secondary battery is viewed such that the electrode terminal is visible from a direction perpendicular to the main surface of the electrode terminal (for example, it may be regarded as an outline of the outer case positioned outside the electrode terminal, an outside outline or an outermost outline of the outer case, or the like).

As described above, in the present disclosure, the plan view outline of the electrode terminal includes both the linear portion and the curved portion, but in such a configuration, a region other than the electrode terminal is easily provided as a suitable region on one main surface of the battery. According to the aspects shown in FIGS. 6(A) to 6(D), both a terminal region 110A and a non-terminal region 110B can be more suitably provided on the battery main surface on which the electrode terminal is provided. In particular, in the plan view outline of the electrode terminal including the linear portion and the curved portion, a suitable or larger ratio of the plan view area of the non-terminal region 110B on the battery main surface can be secured as compared with a case where such an outline configuration of the electrode terminal is not included. Therefore, due to the non-terminal region 110B provided together with the terminal region 110A on the battery main surface, a degree of freedom in designing the battery is further increased. For example, the external lead-out member for external connection is easily provided in the non-terminal region 110B, and the secondary battery of the present disclosure is easily provided as a more suitable battery (for example, a compact battery design in which a circuit or the like provided outside the battery is provided on the main surface of the secondary battery of the present application may be possible). Such a matter is likely to become apparent when the plan view outline of the outer case on the surface of the outer case in contact with the insulating seal member includes a curve, and the curved portion of the electrode terminal and a part of the curve of the outer case face each other.

In addition, since the plan view outline of the electrode terminal includes both the linear portion and the curved portion, both the terminal region and the non-terminal region are easily provided suitably on the battery main surface, and the seal area associated with the electrode terminal is easily secured suitably. That is, the ratio of the plan view area of the non-terminal region 110B is more suitably ensured on the battery main surface without adversely impairing the sealing strength and/or the long life. In other words, since the plan view outline of the electrode terminal includes both the linear portion and the curved portion, it is easy to suitably provide the terminal region and the non-terminal region on the battery main surface while suitably securing the area of the sealing region associated with the electrode terminal with the insulating seal member on the outer case interposed therebetween (hereinafter, also referred to as a “seal area”). This is also likely to become apparent when the plan view outline of the outer case on the surface of the outer case in contact with the insulating seal member includes the curve, and the curved portion of the electrode terminal and the part of the curve of the outer case face each other.

The feature of the plan view outline of the electrode terminal including both the linear portion and the curved portion suitably contributes to a safety mechanism when the in-cell pressure or the like rises, that is, a battery cleavage mechanism. When the in-cell pressure abnormally increases, the electrode terminal is cleaved so as to open outward so that an unintended battery explosion is prevented in advance, and in the secondary battery of the present disclosure, this cleavage is relatively likely to occur from the “linear portion”. That is, the electrode terminal is likely to be cleaved so as to be opened from the linear portion in the plan view outline of the electrode terminal (such cleavage will be described later), and the prediction possibility when an in-cell pressure abnormally increases is increased. That is, it is possible to provide the secondary battery of the present disclosure as a safer battery while avoiding, as much as possible, unpredictability regarding the cleavage mode when the in-cell pressure excessively increases. Such an effect is also likely to become apparent when the plan view outline of the outer case on the surface of the outer case in contact with the insulating seal member includes the curve, and the curved portion of the electrode terminal and the part of the curve of the outer case face each other.

In the secondary battery of the present disclosure, the curved portion of the electrode terminal faces the curve of the outer case, and in a preferred aspect, the linear portion of the electrode terminal also faces the curve of the outer case (curved portion different from the portion where the curved portion of the electrode terminal faces). A more specific description will be given with reference to FIGS. 5(A) to 5(D). As described above, in the secondary battery of the present disclosure, the curved portion 254 in the plan view outline 250 of the electrode terminal 200 and the portion 160a of the curved portion in the plan view outline 160 of the outer case 100 face each other. Such a facing relationship between the electrode terminal and the outer case may also be formed for the linear outline portion of the electrode terminal. The curve in the plan view outline 160 of the outer case 100 may have a portion facing the curved portion 254 of the plan view outline 250 of the electrode terminal 200 and a portion facing the linear portion 252. In plan view shown in FIGS. 5(A) to 5(D), the plan view outline 160 of the outer case 100 is curved as a whole, and a curved portion 160b of the outer case which is different from “the portion 160a of the curve of the outer case 100 which the curved portion 254 of the electrode terminal 200 faces” faces the linear portion 252 of the electrode terminal 200. In such an aspect, an effect of facilitating provision of the above-described external lead-out member, an effect of facilitating provision of a suitable cleavage mechanism, and/or the like are more likely to become apparent.

In the secondary battery of the present disclosure, the curved portion of the electrode terminal and the curve of the outer case face each other, but it is preferable that the plan view curved portion of the electrode terminal is positioned closer to the plan view external outline of the outer case than the other portion (outline portion that is not curved) of the electrode terminal. It can be said that it is preferable that the curved portion of the plan view outline of the electrode terminal is positioned relatively proximal to the curve of the plan view outline of the outer case, as compared to the linear portion of the plan view outline of the electrode terminal. For example, in the plan view shown in FIGS. 5(A) to 5(D), a “separation distance between the curved portion 254 of the electrode terminal 200 and the portion 160a of the curved portion of the outer case 100 facing the curved portion (“shortest separation distance” to be described below) “may be smaller than a “separation distance (“shortest separation distance”) between the linear portion 252 of the electrode terminal 200 and another portion 160b of the curve of the outer case 100 (curved portion 160b different from the portion 160a) facing the linear portion”. This will be described in more detail with reference to FIGS. 6(A) to 6(D). When “a shortest separation distance Lw between the curved portion 254 of the plan view outline 250 of the electrode terminal 200 and the plan view external outline 160 of the outer case 100” and “a shortest separation distance Ls between the linear portion 252 of the plan view outline 250 of the electrode terminal 200 and the plan view external outline 160 of the outer case 100” are compared in the plan view of FIGS. 6(A) to 6(D), Lw is smaller than Ls. It can also be said that the linear portion of the plan view outline of the electrode terminal is positioned relatively distal to the curved portion with respect to the plan view external outline of the outer case. In the case of the electrode terminal having such a plan view outline, the terminal region and the non-terminal region are more suitably provided on the battery main surface, and a desired secondary battery is easily provided. For example, it is easy to provide an external lead-out member for external connection with respect to the non-terminal region. Preferably, it is easy to suitably secure the terminal region and the non-terminal region on the battery main surface while suitably securing the sealing area. Note that the “shortest separation distance Lw” refers to the smallest or shortest distance among distances in a direction orthogonal to a tangent of the curved portion in plan view. Similarly, the “shortest separation distance Ls” refers to the smallest or shortest distance among distances in a direction orthogonal to the linear portion.

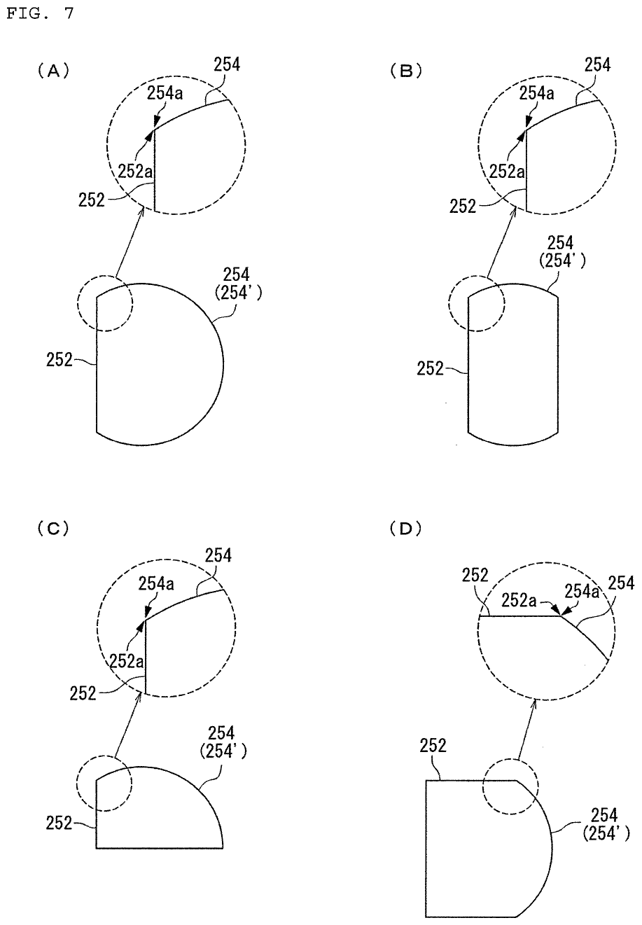

In a preferred aspect, one end portion of the linear portion and one end portion of the curved portion are shared with each other such that the linear portion and the curved portion are continuous (for example, continuously form the plan view outline) in the plan view outline of the electrode terminal. That is, the plan view outline of the electrode terminal is formed from the outline in which the linear portion and the curved portion are connected via their end portions. In the plan view outline of the electrode terminal of FIGS. 7(A) to 7(D) respectively corresponding to FIGS. 6(A) to 6(D), one end portion 252a of the linear portion 252 and one end portion 254a of the curved portion 254 may overlap each other so as to be shared, and thus the plan view outline 250 may be configured so that the linear portion 252 and the curved portion 254 are connected to each other. In the electrode terminal having such a plan view outline, the terminal region and the non-terminal region are more suitably secured on the battery main surface, and a desired secondary battery is easily provided. For example, it is easy to provide an external lead-out member for external connection with respect to the non-terminal region. Preferably, it is easy to suitably provide the terminal region and the non-terminal region on the battery main surface while suitably securing the sealing area.

In plan view outline of the electrode terminal, the curved portion may have an arc shape. That is, the plan view outline of the electrode terminal may include a shape corresponding to a part of a circle. In the aspects shown in FIGS. 7(A) to 7(D), the plan view outline 250 of the electrode terminal may include an arc outline 254′ as the curved portion 254 and the linear portion 252 combined with the arc outline. In the case of the plan view outline of the electrode terminal including such an arc-shaped curved portion, the terminal region and the non-terminal region are more suitably secured on the battery main surface, and preferably the terminal region and the non-terminal region are suitably secured on the battery main surface while suitably securing the sealing area, so that a desired secondary battery is easily obtained. This may become apparent when the secondary battery is a button type or a coin type. For example, it is easy to suitably provide the external lead-out member for external connection for the non-terminal region, and this contributes to more suitable battery design. Although it is merely an example, an arc-shaped curved portion corresponding to the circumference of at least a semicircle, a ¼ circle, a ⅙ circle, or a ⅛ circle may be included in the plan view outline of the electrode terminal.

When the curved portion has an arc shape and the plan view outline of the outer case (particularly, the plan view external outline of the outer case forming the outer edge of the outer case) has a circular shape, a virtual circular shape constituting the arc of the curved portion and a circular shape of the plan view outline of the outer case may be concentric with each other. That is, an arc outline of the electrode terminal and an arc outline of the outer case may share the same circular center in plan view. As a result, it is easy to secure a more uniform and large sealing area between the electrode terminal and the outer case, and as a result, it is possible to more suitably ensure joining strength and long-term reliability with respect to the sealing associated with the electrode terminal (in short, joining of electrode terminals in a peripheral region of the outer case opening). Note that the “concentric circle” in the present specification is not necessarily limited to a fully concentric circle relationship, and includes a substantially concentric circle aspect that can be regarded as having a substantially concentric relationship as recognized by those skilled in the art while being changed from the fully concentric circle relationship (for example, the circle center may be shifted by a distance within 30%, within 20%, within 10%, within 5%, or within 3%, for example, with respect to the diameter of the circle of the plan view outline of the outer case).

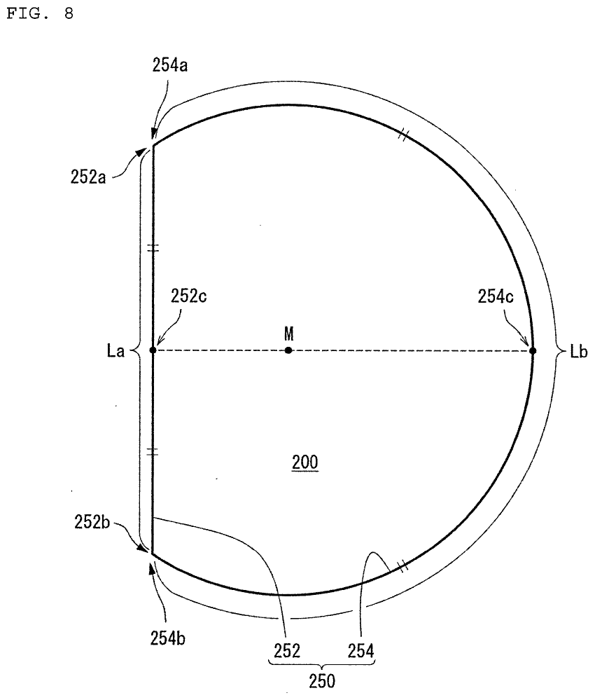

In a preferred aspect, a ratio of the curved portion to the plan view outline of the electrode terminal is relatively larger than a ratio of the linear portion. That is, in the plan view outline of the electrode terminal, a total length of the curved portion may be relatively longer than a total length of the linear portion. When the length of the linear portion 252 is Lₐ and the length of the curved portion 254 is L_{b} in the aspect illustrated in FIG. 8, Lₐ<L_{b} may be satisfied. In the case of the plan view outline of the electrode terminal in which the ratio of the curved portion is larger than the ratio of the linear portion, the terminal region and the non-terminal region are more suitably secured on the battery main surface, and a desired battery is easily obtained. For example, it is easy to provide an external lead-out member for external connection in the non-terminal region. Preferably, it is easy to suitably provide the terminal region and the non-terminal region on the battery main surface while suitably securing the seal area associated with the electrode terminal. Although it is merely an example, the length L_{b} of the curved portion may be 1.2 times or more, for example, 1.5 times or more the length Lₐ of the linear portion. An upper limit value of the length L_{b} of the curved portion is not particularly limited, but may be three times or two times the length Lₐ of the linear portion. Therefore, although it is merely an example, the plan view outline of the electrode terminal may have a relative length relationship such as 1.2Lₐ≤L_{b}≤3Lₐ, 1.2Lₐ≤L_{b}≤2.5Lₐ, 1.2Lₐ≤L_{b}≤2Lₐ, 1.5Lₐ≤L_{b}<3Lₐ, 1.5Lₐ≤L_{b}≤2.5Lₐ, or 1.5Lₐ≤L_{b}≤2Lₐ.

In a preferred aspect, the plan view outline of the electrode terminal includes only the linear portion and the curved portion. For example, as illustrated in FIGS. 6(A) to 6(D), only two types of the linear portion 252 and the curved portion 254 are included. In short, the plan view outline of the electrode terminal may be configured only by a combination of “straight line” and “curve”. In such a case, the features of the present disclosure tend to stand out, and the effects of the present disclosure tend to be apparent. That is, the terminal region and the non-terminal region are more suitably secured on the battery main surface, and for example, an effect of easily providing an external lead-out member for external connection to the non-terminal region can be more apparent. Preferably, the effect that the terminal region and the non-terminal region are suitably provided in a well-balanced manner on the battery main surface while suitably securing the seal area associated with the electrode terminal can be more apparent.

In the secondary battery of the present disclosure, the electrode terminal is provided for the outer case. The electrode terminal may be provided in a region including at least a part of the main surface of the outer case (preferably a part of the planar main surface). In particular, the electrode terminal is provided for the outer case so as to cover at least an opening portion of the outer case (also referred to as an “outer case opening” in the present specification) through which a conductive member electrically connected to the electrode terminal (that is, the conductive member extending from the electrode assembly) passes. Preferably, the electrode terminal is provided on the outer case so as to cover all of the opening of the outer case, and the electrode terminal is preferably provided so as to extend over a planar outer case surface around the opening of the outer case. The “outer case” as used in the present specification means a member configured to house or enclose the electrode assembly having the electrode-constituting layers laminated therein, the electrode-constituting layers including the positive electrode, the negative electrode, and the separator. For example, the outer case may be a metal outer case having a non-laminated configuration. This means that the outer case is not a laminated member or the like including a metal sheet, a fusion layer, and a protective layer. It can be said that the outer case in the present disclosure may be different from an outer case of a soft case type battery corresponding to a pouch formed of a so-called laminated film. The metal outer case having the non-laminated configuration preferably has a configuration including a single metal member. For example, such a metal outer case may be a single member formed of metal such as iron, stainless steel (SUS) and/or aluminum. The term “single metal member” as used herein means that the outer case has no so-called laminate configuration in a broad sense, and means that the outer case is a member made substantially of only a metal in a narrow sense. Therefore, a surface of the metal outer case may be subjected to an appropriate surface treatment as long as the outer case is the member substantially made only of metal. For example, on a cut surface obtained by cutting such a metal outer case in a thickness direction thereof, a single metal layer can be confirmed except for a portion on which surface treatment or the like is performed. The term “stainless steel” in the present specification refers to, for example, stainless steel specified in “JIS G 0203 Glossary of terms used in iron and steel”, and the stainless steel may be chromium or alloy steel containing chromium and nickel. In a preferred aspect, the outer case may have a can form (in such a case, it can be said that the outer case includes an “exterior can”).

In the secondary battery of the present disclosure, the outer case may mainly include two parts. For example, the outer case may include two parts including a first metal outer case and a second metal outer case which are metal members. In the case of an outer case having a non-laminated configuration, each of the first metal outer case and the second metal outer case may be a single metal member. In the present disclosure, the outer case may have a relatively thin thickness. For example, each of the first metal outer case and the second metal outer case may have a thickness dimension of 50 μm or more and less than 200 μm, for example, 50 μm or more and 190 μm or less, 50 μm or more and 180 μm or less, or 50 μm or more and 170 μm or less.

In the outer case including the two parts including the first metal outer case and the second metal outer case, the above-mentioned “outer case opening” may be provided on one of the first metal outer case and the second metal outer case. That is, the opening may be provided on one of the first metal outer case and the second metal outer case, and the electrode terminal may be provided on one of the sub outer cases having the opening. The first metal outer case and the second metal outer case of the metal member may be combined with each other by laser welding to form the outer case, or may be combined with each other by crimping to form the outer case.

One of the first metal outer case and the second metal outer case may be a cup-like member, and the other of the first metal outer case and the second metal outer case may be a lid-like member. In such a case, for example, the metal outer cases may be joined to each other by welding or crimping a peripheral edge portion of the lid-like member from outside, whereby relatively simple sealing can be performed. The “cup-like member” means a member that includes a side wall or a side surface portion corresponding to a body portion and a main surface portion (in a typical aspect, for example, a bottom portion) continuous with the side wall or the side surface portion, and in which a hollow portion is formed. In addition, the “lid-like member” means a member combined so as to cover the cup-like member (preferably, a member provided so as to be in contact with the side wall of the cup-like member to block the hollow portion within the cup-like member from outside). The lid-like member may be, for example, a single member (typically a flat plate-like member) extending in the planar direction (in particular, a direction orthogonal to a direction in which the side wall of the cup-like member extends in an erected manner), and particularly may be a member provided so as to be in contact with the side wall of the cup-like member.

The above-described “outer case opening” may be provided for the lid-like member. That is, the outer case may be formed of a cup-like member 100A and a lid-like member 100B, and not the cup-like member 100A but the lid-like member 100B may have the outer case opening 150 (see FIG. 4). When the lid-like member includes the outer case opening, the electrode terminal is provided for the lid-like member. In such a case, the secondary battery can be manufactured by once obtaining a combination body in which the electrode terminal is provided on the lid-like member, and the secondary battery can be relatively easily obtained.

The “outer case opening” may be provided for the cup-like member. That is, the outer case may include the cup-like member and the lid-like member, and the cup-like member instead of the lid-like member may have the outer case opening (for example, the outer case opening may be provided on a surface corresponding to the bottom portion of the cup-like member). In a case where the cup-like member includes the outer case opening, the electrode terminal may be provided for the cup-like member (for example, on a surface corresponding to the bottom portion of the cup-like member).

When the metal outer case particularly includes the cup-like member and the lid-like member, the cup-like member and the lid-like member may be hermetically sealed by joining to each other. That is, the cup-like member and the lid-like member are not crimped, and thus airtight sealing by crimping need not be performed. As a result, it is easy to obtain a secondary battery that achieves space saving as compared with a secondary battery including an outer case that is joined by crimping. That is, the non-crimped form of the cup-like member and the lid-like member suitably contributes to downsizing and energy density improvement of the secondary battery.

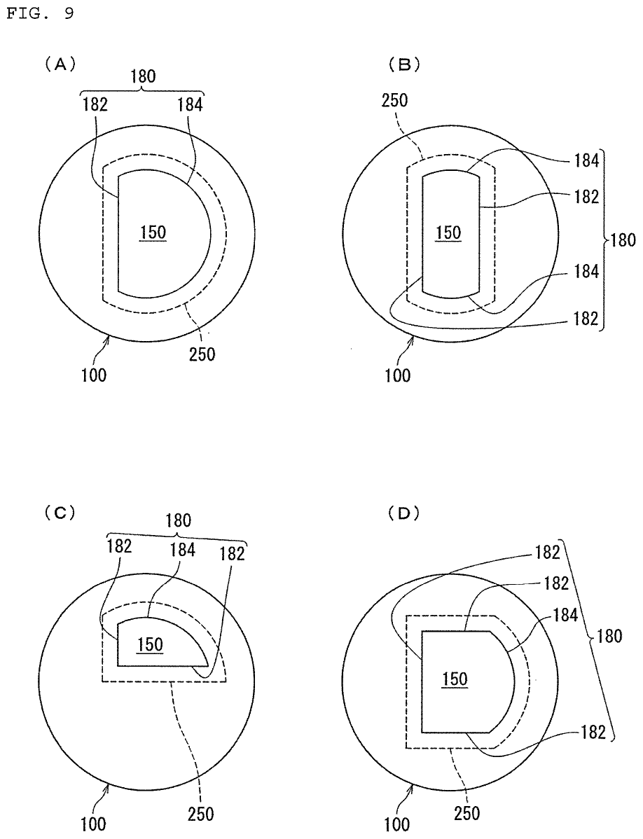

In the present disclosure, the outer case opening may also have an outline shape similar to that of the electrode terminal. That is, in the secondary battery including the conductive member electrically connecting the electrode assembly and the electrode terminal, in which the insulating seal member is interposed between the electrode terminal and the outer case surface around the opening of the outer case through which the conductive member passes, the plan view external outline of the opening of the outer case may be constituted by both the linear portion and the curved portion. FIGS. 9(A) to 9(D) show plan view outlines of the outer case respectively corresponding to FIGS. 5(A) to 5(D) or FIGS. 6(A) to 6(D). In plan view of the outer case 100 shown in FIGS. 9(A) to 9(D) (a plan view shown by excluding the electrode terminals), an outline 180 of the outer case opening 150 includes two types of a linear portion 182 and a curved portion 184. That is, the shape of the opening edge which forms the outer case opening 150 includes the linear portion and the curved outline. In a preferred aspect, the outline 180 of the outer case opening 150 includes only two types of the linear portion 182 and the curved portion 184, and therefore, the shape of the opening edge forming the outer case opening 150 includes only the linear portion and the curved outline.

In the secondary battery including the outer case opening having such a plan view outline, more suitable sealing can be provided. Specifically, the plan view outline of the outer case opening and the plan view outline of the electrode terminal are likely to have a similar relationship, and the sealing of the electrode terminal in the peripheral region of the outer case opening is likely to be more uniform (preferably, the width dimension of the sealing region formed around the outer case opening tends to be constant along the periphery of the opening). That is, a safer battery is easily provided in terms of stable airtight sealing.

In terms of the outline shapes 180 of the outer case opening 150 shown in FIGS. 9(A) to 9(D), the shapes themselves have a similar relationship to the outline shapes 250 of the electrode terminals shown in FIGS. 6(A) to 6(D). Accordingly, the various features described above with respect to the plan view outline 250 of the electrode terminal may similarly apply to the plan view outline 180 of the outer case opening 150.

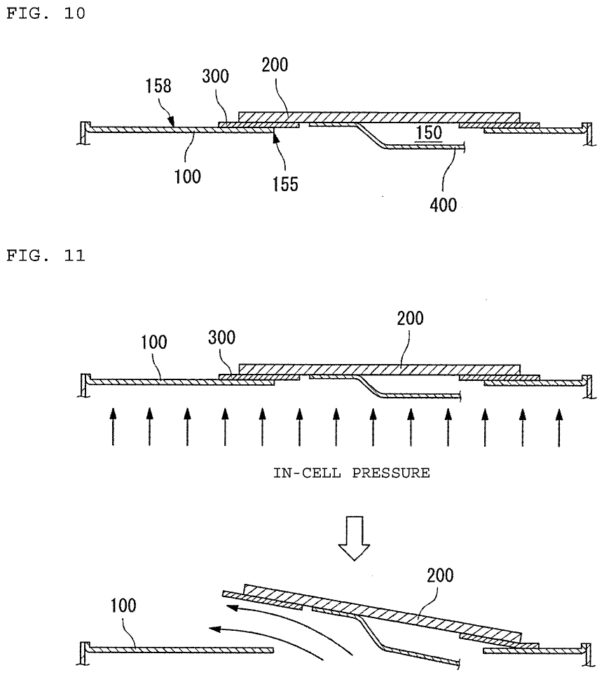

In the secondary battery of the present disclosure, the insulating seal member is provided between the electrode terminal and the outer case. FIG. 10 illustrates a sectional view of a mutual arrangement relationship among the outer case 100, the electrode terminal 200, and the insulating seal member 300. As can be seen from the form illustrated in FIG. 10, the insulating seal member 300 is interposed between the outer case 100 and the electrode terminal 200. The outer case 100 has the outer case opening 150 as an opening portion, and the insulating seal member 300 is disposed on the outer case surface 158 around the outer case opening 150. Preferably, the electrode terminal 200 is joined to the outer case 100 with the insulating seal member 300 interposed therebetween due to the joining property of the insulating seal member 300 in the peripheral region of the outer case opening 150. As shown in FIG. 10, the electrode terminal 200 is preferably stuck on the insulating seal member 300 so as to close the outer case opening 150 from outside. In the secondary battery of the present disclosure according to a preferred aspect, the insulating seal member 300 is interposed between the electrode terminal 200 and the outer case surface 158 around the opening portion 150 of the outer case through which the conductive member 400 passes. As can be seen from FIG. 10, the insulating seal member 300 is sandwiched between the electrode terminal 200 and the outer case 100 in the joining region between the electrode terminal 200 and the outer case 100.

The insulating seal member 300 may be provided along the peripheral edge of the opening portion 150 on the outer case surface (preferably, on the outer surface of the outer case). For more suitable insulation, the insulating seal member 300 may be provided so as to spread to a region outside the electrode terminal 200. That is, for example, as shown in FIGS. 10, the insulating seal member 300 may be provided on the outer case 100 so as to stick out from the electrode terminal 200. Similarly, in order to provide more suitable insulation, the insulating seal member 300 may also be provided inside over the edge of the opening portion 150 of the outer case 100. That is, for example, as shown in FIG. 10, the insulating seal member 300 may extend inward so as to cross over an edge portion 155 forming the opening portion 150 in the outer case 100, and thus a part of the insulating seal member 300 may extend to the region of the opening portion 150.

In the present specification, the “insulating seal member” refers to at least a member that is interposed between the outer case and the electrode terminal and contributes to insulation therebetween, and means a member that also contributes to battery sealing (more specifically, airtight sealing between the outer case and the electrode terminal). The material type of the insulating seal member is not particularly limited as long as the insulating seal member exhibits insulating properties. The term “insulation” as used herein may have an electrical resistivity, that is, the insulation property of a general insulator, and therefore may have an electrical resistivity of the general insulator, and may have a resistivity of at least 1.0×10⁵ Ω·m or more, preferably 1.0×10⁶ Ω·m or more, and more preferably 1.0×10⁷ Ω·m or more (room temperature: 20° C.) although it is merely an example. Preferably, the insulating seal member has not only “insulation properties” but also “fusing properties”. This is because the sealability is more easily improved. For example, the insulating seal member may include a thermoplastic resin. Although it is only one specific example, the insulating seal member may contain polyolefin such as polyethylene and/or polypropylene. When viewed from another aspect, the insulating seal member as the insulating jointing material may easily improve the sealing property, and thus may contain a component of an adhesive exhibiting insulating properties. Examples of such an adhesive material (that is, the material of the insulating seal member) include acrylic-based adhesive materials such as acrylic acid ester copolymers, rubber-based adhesive materials such as natural rubber, silicone-based adhesive materials such as silicone rubber, urethane-based adhesive materials such as a urethane resin, α-olefin-based adhesive materials, ether-based adhesive materials, ethylene-vinyl acetate resin-based adhesive materials, epoxy resin-based adhesive materials, vinyl chloride resin-based adhesive materials, chloroprene rubber-based adhesive materials, cyanoacrylate-based adhesive materials, aqueous polymer-isocyanate-based adhesive materials, styrene-butadiene rubber-based adhesive materials, nitrile rubber-based adhesive materials, nitrocellulose-based adhesive materials, reactive hot-melt-based adhesive materials, phenol resin-based adhesive materials, modified silicone-based adhesive materials, polyamide resin-based adhesive materials, polyimide-based adhesive materials, polyurethane resin-based adhesive materials, polyolefin resin-based adhesive materials, polyvinyl acetate resin-based adhesive materials, polystyrene resin solvent-based adhesive materials, polyvinyl alcohol-based adhesive materials, polyvinyl pyrrolidone resin-based adhesive materials, polyvinyl butyral resin-based adhesive materials, polybenzimidazole-based adhesive materials, polymethacrylate resin-based adhesive materials, melamine resin-based adhesive materials, urea resin-based adhesive materials, and/or resorcinol-based adhesive materials.

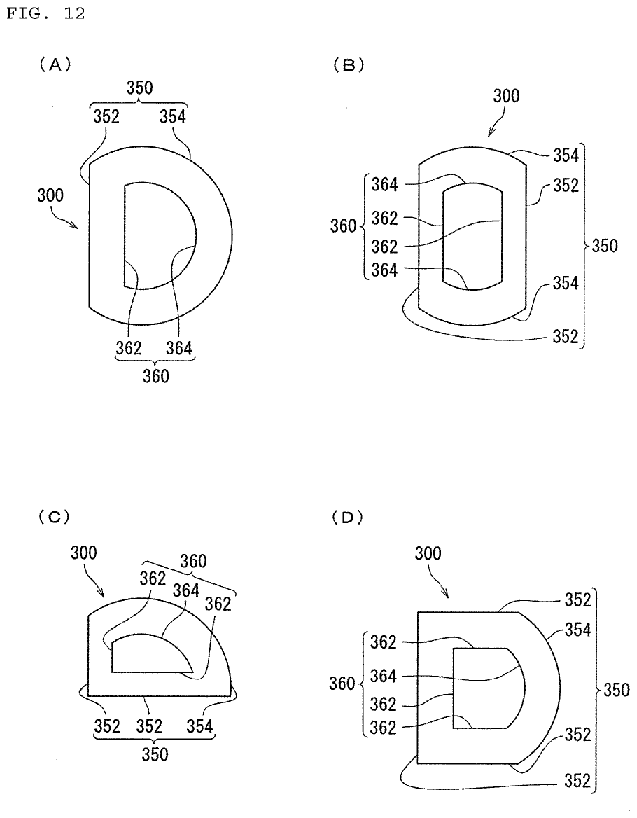

The secondary battery in which the insulating seal member is interposed between the electrode terminal and the outer case surface is easily provided as a safer battery. That is, when an abnormal situation in which the internal pressure of the outer case increases occurs, cleavage that opens the electrode terminal (preferably, cleavage that opens the electrode terminal so as to move toward the outside of the battery) can occur so that a more serious accident such as an unintended battery explosion can be prevented. That is, in order to prevent a burst phenomenon in which a pressure inside the outer case (also referred to as “in-cell pressure” in the present specification) is increased by a gas generated by abnormal heat generation inside the battery due to overcharge, internal short circuit, or the like and the battery explodes, the secondary battery preferably includes a vent mechanism that releases the internal gas when the in-cell pressure is excessively increased. In this respect, the secondary battery of the present disclosure can be preferably displaced so that the sealed state in which the electrode terminal blocks the outer case opening can be released when the in-cell pressure excessively increases. That is, when the in-cell pressure abnormally increases, the electrode terminal is displaced to be opened so as to be peeled from the insulating seal member on the outer case surface (see FIG. 11), and thus the internal gas can be released to the outside due to the outer case opening communicating with outside, and battery explosion and the like can be prevented.

In the present disclosure, the insulating seal member may also have an outline shape similar to that of the electrode terminal. That is, the plan view outline of the insulating seal member may include both the linear portion and the curved portion. FIGS. 12(A) to 12(D) illustrate the plan view outlines of the insulating seal member 300 corresponding to FIGS. 5(A) to 5(D) or FIGS. 6(A) to 6(D), respectively. As illustrated in FIGS. 12(A) to 12(D), the external outline 350 of the insulating seal member 300 includes two types a linear portion 352 and a curved portion 354. That is, the plan view outline of the outer edge of the insulating seal member 300 includes the linear outline and the curved outline. In a preferred aspect, the external outline of the insulating seal member 300 includes only two types of the linear portion and the curved portion, and therefore the plan view outline of the outer edge of the insulating seal member 300 includes only the linear outline and the curved outline. An internal outline of the insulating seal member 300 may be similar. An internal outline 360 of the insulating seal member 300 includes two types of a linear portion 362 and a curved portion 364. That is, the plan view outline of the inner edge of the insulating seal member 300 includes the linear outline and the curved outline. In a preferred aspect, the internal outline of the insulating seal member 300 includes only two types of the linear portion and the curved portion, and therefore the plan view outline of the inner edge of the insulating seal member 300 includes only the linear outline and the curved outline.

In the secondary battery including the insulating seal member 300 having such a plan view outline, more suitable sealing is easily provided. Specifically, the plan view outline of the outer edge and/or the inner edge of the insulating seal member and the plan view outline of the electrode terminal easily have a similar relationship with each other, so that the insulating seal member together with the electrode terminal easily contributes to more uniform sealing of the peripheral region of the outer case opening (preferably, the width dimension of the sealing region formed around the outer case opening tends to be constant along the periphery of the opening). That is, a safer battery can be easily provided in terms of stable airtight sealing.

In terms of the outline shapes of the insulating seal member 300 shown in FIGS. 12(A) to 12(D), the shapes themselves have a similar relationship to the outline shapes 250 of the electrode terminals shown in FIGS. 6(A) to 6(D). Accordingly, the various features described above with respect to the plan view outline 250 of the electrode terminal may similarly apply to the plan view outline 350, 360 of the insulating seal member.

In a preferred aspect, a separation distance between the curved portion 254 of the plan view outline 254 of the electrode terminal 200 and the plan view external outline 160 of the outer case 100 is constant. This applies particularly when the curved portion 250 of the electrode terminal 200 has an arc shape and the plan view outline of the outer case (particularly, the plan view external outline of the outer case forming the outer edge of the outer case) has a circular shape (see FIGS. 6(A) to 6(D)). That is, the “shortest separation distance Lw” described with reference to FIGS. 6(A) to 6(D) may be a constant distance in plan view. Such a constant separation distance contributes to more uniform sealing. That is, the width dimension of the sealing region formed around the outer case opening tends to be constant along the periphery of the opening, and more stable airtight sealing is easily provided.

In a preferred aspect, the electrode terminal in the present disclosure is a non-crimped metal plate. Further, due to such a non-crimped metal plate, for example, the metal plate extends on the same plane in sectional view. In short, the electrode terminal to be an external output terminal does not have a bent form as a whole, and has a flat plate form. For example, as illustrated in FIGS. 3(A) and 10, the electrode terminal 200 may have a rectangular sectional shape. The electrode terminal 200 described above does not receive a history of pressure deformation, and tends to provide long-term stability from the viewpoint of material quality. That is, the external output terminal is likely to be suitable for long-term use of the secondary battery. Due to such a non-crimped configuration, for example, the insulating seal member 300 may also extend on the same plane in sectional view. That is, the sectional shape of the insulating seal member provided so as to be adjacent to the electrode terminal is not a bent shape, and may be, for example, a rectangular shape. As shown in FIGS. 3(A) and 10, the thickness of the insulating seal member 300 may be substantially constant. Such an insulating seal member 300 can be said to be an insulating member or an insulating material in which the action of the pressure deformation is further reduced when the electrode terminal is installed. The insulating seal member 300 may have a film form. For example, the insulating seal member 300 may be provided using a film-like precursor of an insulating member having a form close to the final shape.

Here, the cleavage mechanism associated with the electrode terminal, that is, the vent mechanism will be described in detail. When the in-cell pressure increases with use of the battery such as charging and discharging, the force that the electrode terminal 200 receives also increases due to the in-cell pressure. In a preferred aspect, when the in-cell pressure becomes excessively high, a force applied to the electrode terminal 200 exceeds a joining force (that is, an adhesive force or a fixing force of the electrode terminal 200 to the outer case 100 with the insulating seal member 300 interposed therebetween) between the electrode terminal 200 and the outer case 100, and at least a part of the electrode terminal 200 can be detached from the outer case 100. For example, the electrode terminal 200 is provided so as to cover the opening portion 150 of the outer case 100, and the electrode terminal 200 can be displaced so as to open the lid (see FIG. 11). By such displacement of the electrode terminal 200, excessive gas in the outer case is released to the outside of the outer case, and it is possible to prevent, in advance, a more serious accident such as an unintended battery explosion.

In the present specification, the “in-cell pressure” means a pressure inside the outer case of the secondary battery in a broad sense. In a narrow sense, the “in-cell pressure” means a pressure inside the outer case that includes the electrode assembly and is being brought into an airtight state (in particular, an internal pressure during use of the battery). The “insulating seal member” in this mode contributes to the vent mechanism as described above, and can be referred to as an insulating seal that can be peeled off when the in-cell pressure is abnormal, that is, a peelable member.

The secondary battery of the present disclosure can be provided as a battery having a high possibility of prediction when the in-cell pressure abnormally rises, where the plan view outline of the electrode terminal includes both a linear portion and a curved portion. Specifically, when the in-cell pressure abnormally increases, the electrode terminal is easily cleaved so as to open from a position corresponding to “linear portion” of the plan view outline of the electrode terminal as a starting point, so that the prediction possibility is increased, and more suitable battery design is possible.

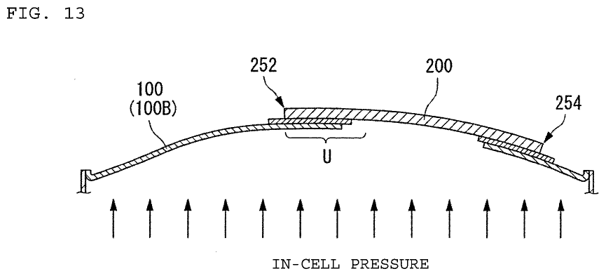

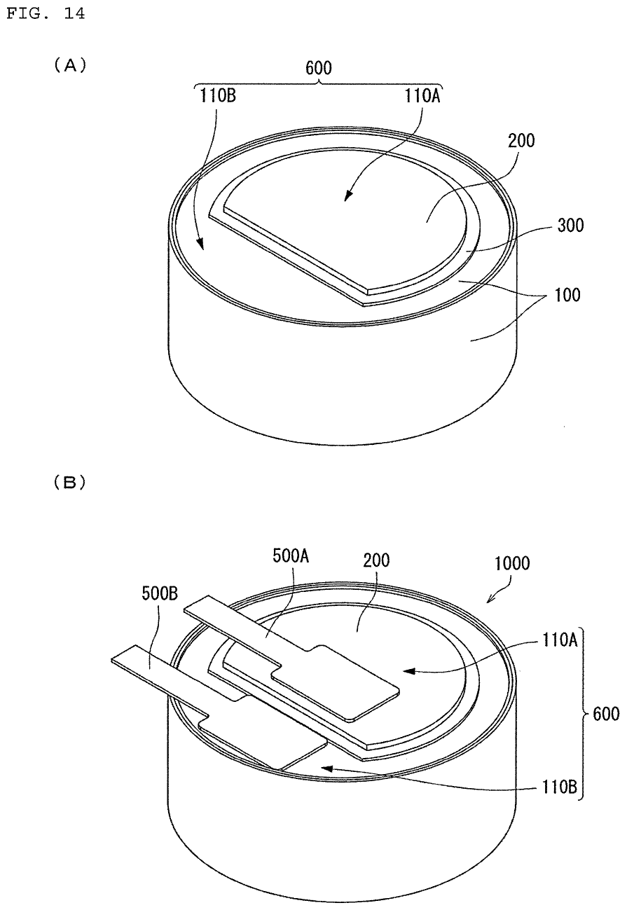

When the in-cell pressure in the secondary battery increases, a stress is exerted on the outer case due to the in-cell pressure. In particular, when the in-cell pressure abnormally increases, a deformation stress that causes deflection or strain may act on the outer case (see FIG. 13). Such a deformation stress easily acts so that the deflection of the center region of the outer case increases. In particular, the main surface of the outer case extending in a substantially planar shape is structurally more easily deflected than the side surface of the outer case which may be provided as a curved surface or a bent surface. Therefore, in the deflection when the in-cell pressure abnormally increases, the center portion in the width direction of the battery main surface portion easily has a larger curvature or bending than the portion on the outer side, and the outer case main surface portion (in the illustrated aspect, the lid-like member 100B) can be deformed as shown in FIG. 13, for example. Due to such deformation of the outer case (that is, deformation of the battery), a portion corresponding to the “linear portion” of the plan view outline of the electrode terminal is preferably positioned at a portion having a relatively large curvature or the vicinity thereof (hereinafter, also referred to as a “maximum curvature portion”). It can also be said that the linear portion 252 of the plan view outline of the electrode terminal 200 is positioned at a maximum curvature portion U relatively proximal to the curved portion 254 (see FIG. 13). Therefore, the linear portion of the plan view outline of the electrode terminal is relatively more susceptible to an influence of the deformation stress of the outer case than the curved portion, and the cleavage in which the electrode terminal is peeled off from the linear portion of the plan view outline of the electrode terminal is likely to occur. Such an effect can be easily seen in the above-described cases where “the curved portion of the electrode terminal and the curve of the outer case face each other”, “the linear portion of the electrode terminal also faces the curve of the outer case (another curved outline portion different from the portion where the curved portion of the electrode terminal faces)”, “the aspect in which the curved portion is positioned relatively proximal to the linear portion with respect to the plan view external outline of the outer case”, and/or “the aspect in which ratio of curved portion to plan view outline is relatively larger than ratio of linear portion (that is, an aspect in which the ratio of the linear portion to the plan view outline is relatively smaller than the ratio of the curved portion)”.

As described above, at the time of cleavage when the in-cell pressure abnormally increases, the electrode terminal is displaced so as to be opened from a position corresponding to the linear portion of the plan view outline of the electrode terminal, and thus the secondary battery of the present disclosure can be more suitably designed on the premise of such cleavage. In other words, such a secondary battery is likely to be a battery in which unpredictability is avoided as much as possible for the cleavage mode related to the outer case, and can be provided as a safer battery.

### [Manufacturing Method for Secondary Battery of the Present Disclosure]

The secondary battery of the present disclosure can be obtained by enclosing the electrode assembly in which the electrode-constituting layers including the positive electrode, the negative electrode, and the separator are laminated in the outer case.

The electrode assembly may be manufactured by a conventional method, and the secondary battery can be obtained by disposing the electrode assembly in the outer case. The outer case is provided with the insulating seal member as a sealing material in a peripheral region of the outer case opening, and the electrode terminal is provided with the insulating seal member interposed therebetween so as to close the outer case opening. For example, in a case where the outer case includes the above-described cup-like member and the lid-like member having a circular shape in plan view, the secondary battery can be obtained through a step of placing the electrode assembly inside the cup-like member and closing the opening end of the cup-like member with the lid-like member (for example, the lid-like member and the cup-like member may be combined with each other through a welding process or the like), and a step of providing the insulating seal member in the peripheral region of the outer case opening of the outer case, and providing the electrode terminal on the outer case with the insulating seal member interposed therebetween such that the outer case opening is covered.

The electrode terminal itself having the plan view outline including both the linear portion and the curved portion can be obtained by a conventional metal working method. The type of the metal working method per se is not particularly limited. For example, the electrode terminal may be obtained through machining (for example, cutting and/or grinding, etc.), plastic working (for example, pressing and/or forging, etc.), and/or casting (sand casting and/or die casting). Alternatively, the electrode terminal may be manufactured using a metal 3D printer.

The present disclosure can be embodied in various aspects. This will be described below.

### (Aspect of Single Linear Portion and Curved Portion)

This aspect is characterized in the number of outline components of the plan view outline of the electrode terminal. Specifically, the plan view outline of the electrode terminal includes a single linear portion and a single curved portion. That is, in the plan view outline of the electrode terminal, each of the two types of outline components is provided as a single component.

For example, in the plan view outline 250 of the electrode terminal 200 illustrated in FIG. 8, only one linear portion 252 constituting the outline is provided, and only one curved portion 254 is also provided. In this aspect, in the plan view outline 250 of the electrode terminal 200, the one end portion 252a of the linear portion 252 and the one end portion 254a of the curved portion 254 are preferably shared with each other, and the other end portion 252b of the linear portion 252 and the other end portion 254b of the curved portion 254 are preferably shared with each other such that the linear portion 252 and the curved portion 254 are continuous.

In this aspect, in the plan view outline, the center point of the linear portion and the center point of the curved portion may face each other across a battery center. In plan view illustrated in FIG. 8, a center point 252c dividing the linear portion 252 into half and a center point 254c dividing the curved portion 254 into half face each other across a battery center M. The plan view outline 250 may be configured so as to surround the battery center M and form a closed region by the single curved portion 254 and the single linear portion 252. The “battery center M” as used herein refers to the center of the main surface of the secondary battery in a broad sense, and refers to the center of the shape of the plan view external outline of the outer case in a narrow sense (for example, when the shape of the external outline of the outer case in plan view is circular, the center of the circle corresponds to the “battery center M”).

In a case where the plan view outline of the electrode terminal is constituted by the single linear portion and the single curved portion, it is easy to suitably secure the terminal region and the non-terminal region on the battery main surface, and it is easy to obtain a desired battery. For example, an external lead-out member for external connection (that is, a member provided separately from the electrode terminal for external output) can be easily provided in the non-terminal region, and this contributes to more suitable battery design. Preferably, both the terminal region and the non-terminal region are easily suitably secured on the battery main surface while suitably securing the sealing area.

In the exemplified aspect of FIG. 8, the plan view outline of the electrode terminal may have an “arcuate shape”, a “D shape”, and/or a “half-moon shape”. In particular, an electrode terminal having an arcuate shape, a D shape, and/or a half-moon shape may be provided on the main surface of the battery so as to extend to the “battery center M”. Further, as can be seen from the exemplified aspect of FIG. 8, in the secondary battery of the present disclosure, the electrode terminal including both a plan view linear outline and a plan view curved outline may extend on one side of the battery from the battery center. That is, by setting the outline of the electrode terminal to be an outline including both the plan view linear outline and the plan view curved outline, it becomes easy to secure a large seal area as desired while bringing the electrode terminal to one side from the center, and it becomes easy to secure an exposed area of the outer case (particularly, an area of the non-terminal region on the main surface of the outer case where the electrode terminal is provided) to be large as desired without impairing the sealing strength and/or the long life.

This aspect relates to a battery configuration that contributes to more suitable external connection. Specifically, both one external lead-out member and the other external lead-out member for external connection are provided on the same battery main surface. Here, the same battery main surface can correspond to a battery surface including the electrode terminal and the outer case. That is, on the battery main surface on which the electrode terminal is provided (hereinafter, also referred to as a “terminal-mounted battery surface”), both one external lead-out member and the other external lead-out member are provided on the battery main surface.

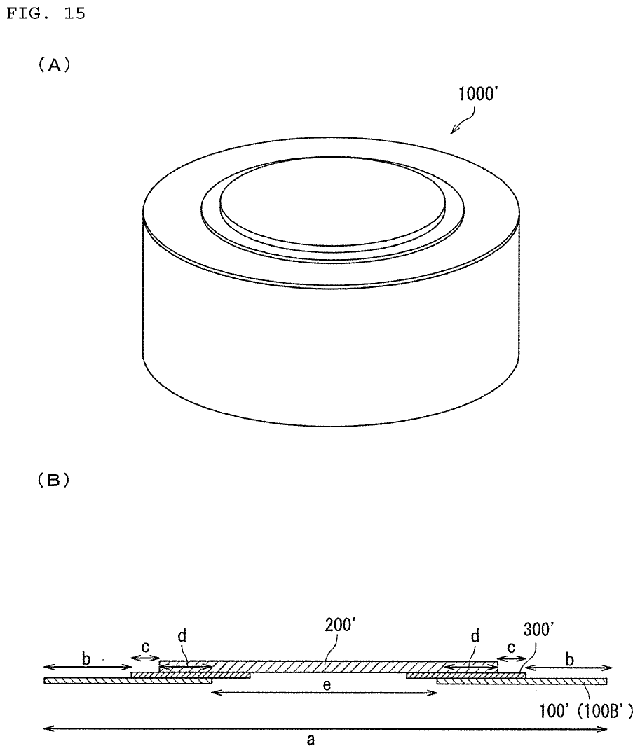

FIGS. 14(A) and 14(B) illustrate an aspect in which a pair of external lead-out members 500A and 500B are provided on the terminal-mounted battery surface 600 including the terminal region 110A and the non-terminal region 110B. As shown in FIG. 14(B), the external lead-out member 500A on the positive electrode side for connection to the outside such as an external circuit and/or an external device and the negative-electrode-side external lead-out member 500B on the negative electrode side for connection similarly to the outside such as an external circuit and/or an external device are provided on the terminal-mounted battery surface 600. Such a configuration of the secondary battery is caused by the plan view outline of the electrode terminal including both the linear portion and the curved portion. That is, this is because the terminal region 110A and the non-terminal region 110B are more suitably provided on the terminal-mounted battery surface due to the plan view outline of the electrode terminal including the linear portion and the curved portion. In such a plan view outline, the non-terminal region 110B can be provided as a region where an external lead-out member for external connection is easily provided such that the non-terminal region 110B becomes a larger region (in particular, a larger region as compared to the case where the plan view outline of the electrode terminal does not have both the linear portion and the curved portion). Therefore, preferably, both the one external lead-out member and the other external lead-out member can be suitably provided on the terminal-mounted battery surface. In the secondary battery according to such an aspect, the external lead-out members are suitably aggregated on one battery main surface, and the secondary battery is more suitable in terms of external connection.

One of the two external lead-out members provided on the terminal-mounted battery surface may be provided on the electrode terminal, and the other may be provided in the non-terminal region. That is, one external lead-out member may be provided with respect to the electrode terminal, and the other external lead-out member may be provided with respect to a non-terminal region which is a region other than the electrode terminal in the battery main surface. As a result, the terminal-mounted battery surface can be more effectively utilized while the conductive functions of the two external lead-out portions are maintained as desired. As shown in FIG. 14(B), the one and the other of the external lead-out members may be provided side by side (preferably side by side so as to be adjacent to each other) on the battery main surface. Although it is merely an example, at least a part of the external lead-out member on the positive electrode side may be disposed on the electrode terminal so as to be electrically connected to the electrode terminal, and at least a part of the external lead-out member on the negative electrode side may be disposed on the non-terminal region so as to be electrically connected to the non-terminal region. Alternatively, in an opposite aspect, at least a part of the external lead-out member on the negative electrode side may be disposed on the electrode terminal so as to be electrically connected to the electrode terminal, and at least a part of the external lead-out member on the positive electrode side may be disposed on the non-terminal region so as to be electrically connected to the non-terminal region.

The external lead-out members 500A and 500B forming a pair may be members having the same form or shape as each other. Alternatively, the pair of external lead-out members 500A and 500B may be members having different forms or shapes from each other. For example, as illustrated in FIG. 14(B), each of the external lead-out members 500A and 500B may have an elongated shape. The material of the external lead-out members is not particularly limited as long as the material has electrical conductivity. For example, the material of the external lead-out members 500A and 500B may be a metal material generally used for electrical connection of batteries. For example, each of the external lead-out members 500A and 500B may be a member containing at least one metal selected from the group consisting of iron, SUS, aluminum, nickel, and copper. In the present disclosure, the external lead-out member is provided to suitably connect the battery to the outside (for example, an element requiring energy of the battery of the present disclosure such as an external circuit and/or an external device), and thus can also be referred to as an “external output tab”, a “conductive member for external connection”, or the like. Therefore, in the secondary battery of the present disclosure, the external lead-out member serving as the external output tab can be suitably attached to the same surface, and furthermore, a compact battery design including the external circuit is possible.

For example, the secondary battery of the present disclosure may include an external circuit above the terminal-mounted battery surface, and the external circuit and the terminal-mounted battery surface may be electrically connected by the two external lead-out members provided on the terminal-mounted battery surface. Preferably, both the one and the other of the external lead-out members are positioned between the terminal-mounted battery surface and the external circuit. The external circuit suitably disposed above the terminal-mounted battery surface contributes to realization of a compact battery pack at least due to external lead-out members on the positive electrode side and the negative electrode side provided on the same battery main surface (main surface on the upper end side). Preferably, the external circuit disposed above the terminal-mounted battery surface has a plan view size equal to or smaller than that of the terminal-mounted battery surface.

### (Secondary Battery Having Circular Shape in Plan View)

In this aspect, an overall plan view shape of the secondary battery is a circular shape. That is, the secondary battery 1000 is a button type or a coin type in terms of an outer shape (for example, see FIG. 2).

The fact that the plan view shape of the secondary battery is circular means that the shape of the electrode assembly or the outer case including the electrode assembly can be circular when the electrode assembly is viewed from above or below.

The “circular shape” as used herein is not limited to a perfect circular shape (that is, simply a “circle” or a “perfect circle”), and includes a substantially circular shape that can be usually included in a “round shape” as recognized by those skilled in the art while being changed from the perfect circular shape. For example, not only a circle or a perfect circle but also a circle whose arc has a locally different curvature may be used, and furthermore, a circle such as an ellipse or a shape derived from a perfect circle may be used. In a typical example, a battery having such a circular shape in plan view corresponds to a so-called button type or coin type battery. In a preferred exemplified aspect, the secondary battery of the present disclosure is a cylindrical battery.

In such an aspect of the secondary battery having an arc shape in plan view, the curvature in the plan view outline of the outer case is arcuate, and may have a portion facing the curved portion of the plan view outline of the electrode terminal and a portion facing the linear portion of the plan view outline of the electrode terminal. That is, for example, as shown in plan views of FIGS. 5(A) to 5(D), the arc portion 160b of the outer case outline different from “the arc portion 160a of the outer case 100 which the curved portion 254 of the electrode terminal 200 faces” may face the linear portion 252 of the electrode terminal 200.

In the secondary battery having a circular shape in plan view, the plan view outline of the outer case opening (that is, a plan view opening outline) may include both the linear portion and the curved portion. For example, the shape of the plan view opening outline of the outer case opening is similar to that of the plan view outline of the electrode terminal, and is preferably a similar shape having an area smaller than the plan view outline of the electrode terminal. In the present disclosure, although the plan view external outline of the outer case (that is, an outline of the portion forming the outer edge) is circular, the plan view outline of the electrode terminal, the plan view opening outline of the outer case opening, the plan view external outline of the insulating seal member, and/or the plan view internal outline of the insulating seal member are non-circular, and preferably, each of these outlines may include both a linear portion and a curved portion.

In a preferred aspect, because of the button type or coin type battery, a dimension in an axial direction of the secondary battery (for example, a normal direction of a main surface of the battery) is smaller than a width dimension (diameter dimension). However, the secondary battery of the present disclosure is not limited thereto, and the dimension in the axial direction of the secondary battery (for example, the normal direction of the main surface of the battery) may be the same as or larger than the width dimension (diameter dimension).

In this aspect, the secondary battery as a whole is relatively small. That is, the secondary battery may be a small battery.

For example, the width dimension of the secondary battery or the outer case (for example, the dimension in the direction orthogonal to the normal direction or the perpendicular direction of the battery main surface) may be on the order of millimeters. For example, the width dimension of the secondary battery or the outer case (when the width dimension is not constant, the maximum dimension among them) may be about 5 mm or more and 50 mm or less, and may be, for example, 5 mm or more and 40 mm or less, 5 mm or more and 30 mm or less, or 5 mm or more and 20 mm or less. The lower limit value is not limited to 5 mm, and may be 10 mm (not including 10 mm). That is, the width dimension of the secondary battery or the outer case described above may be about greater than 10 mm and less than or equal to 50 mm, and may be, for example, greater than 10 mm and less than or equal to 40 mm, greater than 10 mm and less than or equal to 30 mm, greater than 10 mm and less than or equal to 20 mm, greater than 10 mm and less than or equal to 18 mm, or the like. In the case of a cylindrical battery, the width dimension of the secondary battery can correspond to the diameter dimension of the outer case (for example, the lid member).

In the secondary battery according to such an aspect, the terminal region and the non-terminal region are more suitably ensured on the battery main surface while being small as described above. That is, it is possible to suitably provide an external lead-out member for external connection for the non-terminal region while using a small battery on the order of millimeters (for example, a small cylindrical battery). For example, the battery may be a battery in which both an external lead-out member on the positive electrode side and an external lead-out member on the negative electrode side are provided on a single battery main surface of such a small battery.

Although an embodiment of the present disclosure has been described above, only typical examples have been illustrated. Therefore, the present disclosure is not limited thereto.

For example, although the cleavage mechanism, that is, the vent mechanism has been described above, in the vent mechanism, the conductive member connected to the electrode terminal may have an “allowance” so that the electrode terminal is more suitably opened. That is, when there is no margin in the length of the conductive member connected to the electrode terminal, the presence of the conductive member itself can be a resistance against the opening of the electrode terminal. Therefore, the length of the conductive member between the electrode assembly and the electrode terminal may be relatively long to such an extent that opening of the electrode terminal is not undesirably hindered (particularly, the length may be longer than a length of a conventional conductive member). That is, the conductive member may have a length in which excessive tension that hinders the opening of the electrode terminal does not act between the electrode terminal and the electrode assembly. For example, the conductive member extending from the electrode assembly may be connected to the electrode terminal with deflection and/or bending.

As for the vent mechanism, in the secondary battery of the present disclosure, when the electrode terminal and the outer case are compared, the electrode terminal may have higher rigidity. In other words, at least a part of the outer case may have lower rigidity than the electrode terminal. For example, the exterior portion having the surface on which the electrode terminal is disposed may have lower rigidity than the electrode terminal. Conversely, the electrode terminal may have relatively higher rigidity than the exterior portion having the surface on which the metal plate is disposed. Such a difference in rigidity contributes to realization of a more suitable vent mechanism. In case of abnormality such as an excessive rise in in-cell pressure, the electrode terminal is less likely to be deformed due to its high rigidity, but the exterior portion constituting the surface on which the electrode terminal is disposed can be deformed. As a result, the joint surface of the insulating seal member is easily peeled off, and the electrode terminal easily opens. Although it is merely an example, the thickness of the exterior portion forming the surface on which the electrode terminal is disposed (for example, the thickness of the lid-like member in a case where the outer case includes the lid-like member and the cup-like member) may be 170 μm or less. When the thickness of the exterior portion is 170 μm or less, the outer case is easily deformed in case of abnormality such as an excessive rise in in-cell pressure, and the electrode terminal easily opens as a vent mechanism. In other words, when the thickness of the exterior portion is larger than 170 μm (for example, when the thickness is 200 μm or more), the outer case is not easily deformed in case of abnormality, and the electrode terminal 200 is less likely to open as intended. The lower limit of the thickness of such a thin exterior portion is not particularly limited, but may be, for example, 50 μm or more and 170 μm or less. When the opening portion 150 is provided in the lid-like member 100B of the outer case 100 shown in FIG. 4 and the electrode terminal 200 is disposed, the thickness of the lid-like member 100B may be smaller than the thickness of the electrode terminal 200. Since the lid-like member 100B alone forms the “case portion that provides the surface on which the electrode terminal is disposed”, it is easy to provide the lid-like member as a member having a small thickness, and thus, the lid-like member tends to be a member that is easily deformed so as to be deflected or strained.

In the above description, an aspect in which the outer case includes the cup-like member and the lid-like member has been described, but the present disclosure is not necessarily limited thereto. For example, the outer case may be configured by cup-like members. That is, each of the first metal outer case and the second metal outer case may be a cup-like member. In other words, the outer case may be formed of at least the first metal outer case which is the cup-like member and the second metal outer case which is also the cup-like member. In this case, the first metal outer case and the second metal outer case of the cup-like member may be combined so that side walls thereof are aligned with each other to form the outer case. The “outer case opening” described above may be provided on the cup-like member of any one of the first metal outer case and the second metal outer case, and therefore the electrode terminal and the insulating seal member may be provided on the cup-like member. Furthermore, in a case where the outer case includes the cup-like member and the lid-like member, although it has been mentioned that the outer case opening is provided in the lid-like member, the present disclosure is not necessarily limited thereto. The outer case opening may be provided in the cup-like member.

In the above description, the modes (FIG. 10) in which the insulating seal member 300 is provided on the outer case 100 so as to stick out from the electrode terminal 200 have been mentioned, but the present disclosure is not necessarily limited thereto. The insulating seal member may be provided so as not to protrude outward from the electrode terminal and to be hidden under the electrode terminal. For example, the insulating seal member may be provided so as to substantially align to the outer edge of the electrode terminal, or to be only inside it.

Further, in the above description, an aspect in which the end portion of the linear portion and the end portion of the curved portion are shared with each other with respect to the plan view outline of the electrode terminal has been mentioned, but the shape of the shared portion between the linear portion and the curved portion is not particularly limited. For example, the plan view shape of the shared portion between the linear portion and the curved portion may be a rounded shape or an angular shape.

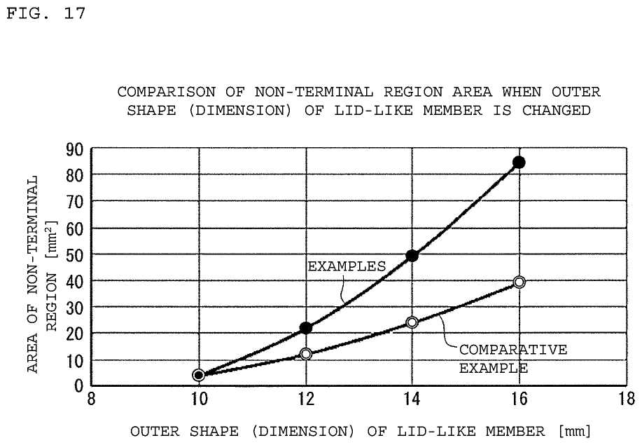

In addition, in the above description, the non-terminal region has been mentioned, and the non-terminal region may particularly refer to a region as mentioned in EXAMPLES described later. That is, in the region surrounded by the imaginary straight line Ly obtained by extending the linear outline of the electrode terminal as it is and the external outline 160 of the outer case, a region R on the side not including the electrode terminal 200 may be particularly regarded as the “non-terminal region” (see the right side of FIG. 16(B)). When there are a plurality of linear outlines, a summed region of regions similarly formed for each linear outline (a summed region including any one of overlapping portions) may be regarded as the non-terminal region.

In the present disclosure, the “plan view outline of the electrode terminal on the surface where the electrode terminal is in contact with the insulating seal member” may be simply regarded as the “external outline of the electrode terminal when the secondary battery is viewed from outside”. Similarly, the “plan view outline of the outer case on the surface where the outer case is in contact with the insulating seal member” may be simply regarded as the “external outline of the outer case when the secondary battery is viewed from outside (particularly, the battery surface on which the electrode terminal is installed is viewed from outside) “. For example, when the outer case includes the above-described lid-like member and the lid-like member is provided for the opening portion (opening portion through which the conductive member passes), the plan view outline, the plan view external outline, or the outermost plan view outline of the lid-like member may be regarded as the “plan view outline of the outer case on the surface where the outer case is in contact with the insulating seal member”. When the lid-like member has a form in which an outer edge thereof is bent toward the outside of the battery as shown in, for example, FIGS. 3(A) and 3(B), and FIG. 10, a plan view outline of a portion excluding the bent outer edge can be regarded as the “plan view outline of the outer case on the surface where the outer case is in contact with the insulating seal member” (by way of example only, the outline denoted by reference numeral 160′ in FIG. 3 can be regarded as the outline described here). In another method, a plan view outline of the lid-like member of the whole member including the bent outer edge (that is, the plan view outline of the lid-like member as a whole when viewed from outside including the outer edge) may be regarded as the “plan view outline of the outer case on the surface where the outer case is in contact with the insulating seal member”. Furthermore, when the lid-like member and the cup-like member are airtightly combined with each other in the outer case, so that the outer edge outline of the lid-like member and the outer edge outline of the cup-like member can have the same shape in plan view (for example, substantially the same or similar shape), the outer edge outline of the cup-like member in plan view may be regarded as the “plan view outline of the outer case on the surface where the outer case is in contact with the insulating seal member”.

Aspects of the secondary battery of the present disclosure are as follows according to an embodiment.

<1> A secondary battery including:
an electrode assembly;
an outer case accommodating the electrode assembly; and
an electrode terminal disposed on the outer case, the electrode terminal being electrically connected to the electrode assembly via a conductive member,
in which the electrode terminal and the outer case are adhered to each other by an insulating seal member (or an insulating member) interposed between the electrode terminal and the outer case and provided around an opening of the outer case through which the conductive member passes, and
a plan view outline of the electrode terminal on a surface of the electrode terminal in contact with the insulating seal member includes both a linear portion and a curved portion, a plan view outline of the outer case on a surface of the outer case in contact with the insulating seal member includes a curve, and the curved portion of the electrode terminal and a part of the curve of the outer case face each other.

<2> The secondary battery according to <1>, in which the linear portion of the electrode terminal faces the curve different from the part of the outer case.

<3> The secondary battery according to <1> or <2>, in which one end portion of the linear portion and one end portion of the curved portion are shared with each other such that the linear portion and the curved portion are continuous in the plan view outline of the electrode terminal.

<4> The secondary battery according to any one of <1> to <3>, in which in the plan view outline of the electrode terminal, a ratio of the curved portion is relatively larger than a ratio of the linear portion.

<5> The secondary battery according to any one of <1> to <4>, in which the curved portion has an arc shape in the plan view outline of the electrode terminal.

<6> The secondary battery according to any one of <1> to <5>, in which the curved portion is positioned relatively proximal to the curve of the outer case as compared to the linear portion of the electrode terminal.

<7> The secondary battery according to any one of <1> to <6>, including two external lead-out members for external connection,
in which both one and another of the external lead-out members are provided for a same battery main surface, and
the same battery main surface corresponds to a battery surface constituted by the electrode terminal and the outer case.

<8> The secondary battery according to <7>, in which the one of the external lead-out members is provided for the electrode terminal, and the other of the external lead-out members is provided for a non-terminal region which is a region other than the electrode terminal in the same battery main surface.

<9> The secondary battery according to any one of <1> to <8>, in which the plan view outline of the electrode terminal is constituted by the single linear portion and the single curved portion.

<10> The secondary battery according to any one of <1> to <9>, in which a plan view opening outline of the opening of the outer case includes both a linear portion and a curved portion.

<11> The secondary battery according to any one of <1> to <10>, in which a plan view outline of the insulating seal member includes both a linear portion and a curved portion.

<12> The secondary battery according to any one of <1> to <11>, in which as electrodes of the electrode assembly, a positive electrode and a negative electrode that are capable of occluding and releasing lithium ions are provided.

### Examples

Model studies were conducted in connection with the present disclosure. Specifically, simulation was performed on the area of the non-terminal region on the battery main surface.

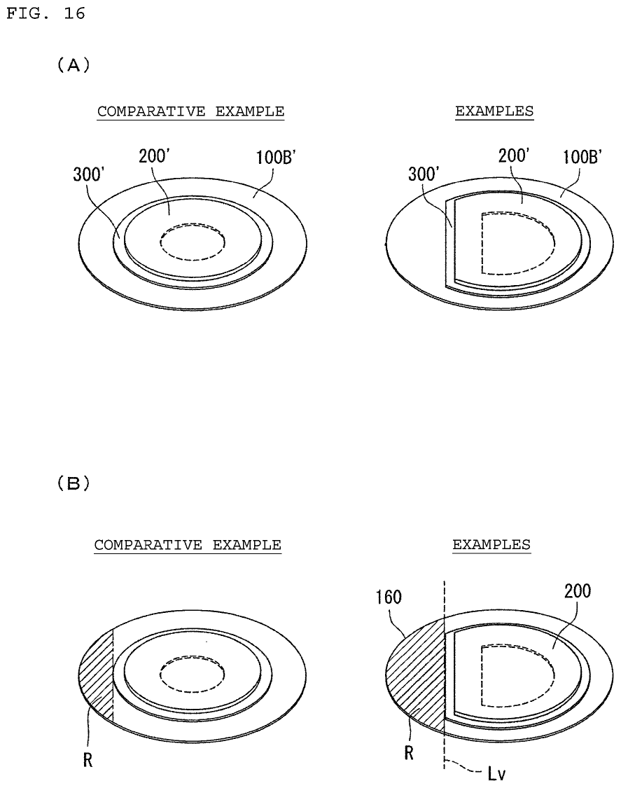

A virtual battery 1000′ as an assumed base is shown in FIGS. 15(A) and 15(B). The following items were set as preconditions for the virtual battery.
The battery has a cylindrical shape as a whole. The electrode terminal is attached on the upper surface side of the cylindrical battery with the insulating seal member interposed therebetween. A lid member is joined to a can member by laser welding at an outer periphery thereof.
The lid member has an outer diameter (a) of 12 mm.
A distance (b) between the outer periphery of the lid member and the insulating seal member is set to 1 mm or more, so that the insulating seal member is not affected by heat when the outer periphery of the lid member is laser-welded.
The insulating seal member is slightly larger than the electrode terminal, and its clearance (c) is 0.5 mm on one side.
A seal distance (d) for securing adhesive strength and long-term reliability is set to 1.5 mm or more.
As a lid hole size necessary for connecting an internal conduction tab inside a cell, a short side distance (e) of the hole is set to 4 mm or more.

FIG. 16(A) shows a schematic diagram in which configurations of the example and the comparative example are modeled based on the above preconditions. In FIG. 16(A), the can member is schematically illustrated, and the lid member is also illustrated as a simple flat plate shape.

Regarding the models in FIG. 16(A), FIG. 16(B) shows a schematic diagram comparing an effective area of the non-terminal region which can be substantially used for installation of the external lead-out member in the lid member (hereinafter, also simply referred to as a “non-terminal region area”) between the example and the comparative example. As shown in FIG. 16(B), it has been found that the non-terminal region area R can be made larger in the example, and a wider area for connecting the external lead-out members can be secured. FIG. 17 shows a graph relating to a change in the non-terminal region area when a dimension (the outer diameter of the lid member) a in the precondition is changed. As shown in the graph of FIG. 17, it has been found that under the above preconditions, when the dimension a is larger than 10 mm, it can be substantially significant from the viewpoint of the non-terminal region area, and the larger the dimension a is, the more remarkable it can be.

The effect of the above-described examples is merely one example. Therefore, the present disclosure is not limited to the above matters, and may have an additional effect.

### INDUSTRIAL APPLICABILITY

The secondary battery according to the present disclosure can be used in various fields in which battery use or electricity storage is assumed. The secondary battery of the present disclosure can be used in the fields of electricity, information, and communication in which electrical/electronic equipment and the like are used (for example, the fields of electrical/electronic equipment and mobile equipment including mobile phones, smartphones, notebook computers, digital cameras, activity meters, arm computers, electronic paper, wearable devices, and small electronic machines such as RFID tags, card type electronic money, and smartwatches), home and small industrial applications (for example, the fields of electric tools, golf carts, and home, nursing, and industrial robots), large industrial applications (for example, the fields of forklifts, elevators, and harbor cranes), transportation system fields (for example, the fields of hybrid vehicles, electric vehicles, buses, trains, power-assisted bicycles, electric two-wheeled vehicles), power system applications (for example, the fields of various types of power generation, road conditioners, smart grids, and household power storage systems), medical applications (the field of medical equipment such as earphone hearing aids), pharmaceutical applications (the fields of dosage management systems and the like), IoT fields, space and deep sea applications (for example, the fields of space probes and submersibles), and the like, as merely examples.

### DESCRIPTION OF REFERENCE SYMBOLS

1: Positive electrode
2: Negative electrode
5: Electrode configuration
10: Electrode assembly
100: Outer case
100A: Cup-like member
100B: Lid-like member
110A: Terminal region
110B: Non-terminal region
150: Outer case opening
155: Outer case opening edge
158: Outer case surface
160: Plan view outline of outer case/external outline of outer case (external outline of secondary battery)
160′: Plan view outline of outer case/external outline of outer case (external outline of secondary battery)
160a: Curved portion of external outline of outer case facing plan view curved outline portion of electrode terminal
160b: Curved portion of external outline of outer case facing plan view linear outline portion of electrode terminal
180: Outline of outer case opening
182: Linear portion of outline of outer case opening
184: Curved portion of outline of outer case opening
200: Electrode terminal
250: Plan view outline of electrode terminal
252: Linear portion
252a: One end portion of linear portion
252b: The other end portion of linear portion
252c: Half-divided point of linear portion
254: Curved portion
254′: arc outline
254a: One end portion of curved portion
254b: The other end portion of curved portion
254c: Half-divided point of curved portion
300: Insulating seal member
350: External outline of insulating seal member
352: Linear portion of external outline of insulating seal member
354: Curved portion of external outline of insulating seal member
360: Internal outline of insulating seal member
362: Linear portion of internal outline of insulating seal member
364: Curved portion of internal outline of insulating seal member
400: Conductive member
500A: External lead-out member
500B: External lead-out member
600: Terminal-mounted battery surface (same battery main surface)
1000: Secondary battery
Lw: Distance (shortest distance) between curved portion of electrode terminal and external outline of outer case
Ls: Distance (shortest distance) between linear portion of electrode terminal and external outline of outer case
Lv: Extended imaginary straight line of linear outline
M: Battery center
U: Maximum curvature portion
1000′: Virtual battery assumed in simulation
100′: Outer case of virtual battery
100B′: Lid-like member of virtual battery
200′: Electrode terminal of virtual battery
300′: Insulating seal member of virtual battery

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an electrode assembly;
an outer case accommodating the electrode assembly; and
an electrode terminal disposed on the outer case, the electrode terminal being electrically connected to the electrode assembly via a conductive member,
wherein the electrode terminal and the outer case are adhered to each other by an insulating seal member interposed between the electrode terminal and the outer case and provided around an opening of the outer case through which the conductive member passes, and
a plan view outline of the electrode terminal on a surface of the electrode terminal in contact with the insulating seal member includes both a linear portion and a curved portion, a plan view outline of the outer case on a surface of the outer case in contact with the insulating seal member includes a curve, and the curved portion of the electrode terminal and a part of the curve of the outer case face each other.

2. The secondary battery according to claim 1, wherein the linear portion of the electrode terminal faces the curve different from the part of the outer case.

3. The secondary battery according to claim 1, wherein one end portion of the linear portion and one end portion of the curved portion are shared with each other such that the linear portion and the curved portion are continuous in the plan view outline of the electrode terminal.

4. The secondary battery according to claim 1, wherein in the plan view outline of the electrode terminal, a ratio of the curved portion is larger than a ratio of the linear portion.

5. The secondary battery according to claim 1, wherein the curved portion has an arc shape in the plan view outline of the electrode terminal.

6. The secondary battery according to claim 1, wherein the curved portion is positioned relatively proximal to the curve of the outer case as compared to the linear portion of the electrode terminal.

7. The secondary battery according to claim 1, comprising two external lead-out members for external connection,
wherein both one and another of the external lead-out members are provided for a same battery main surface, and
the same battery main surface corresponds to a battery surface constituted by the electrode terminal and the outer case.

8. The secondary battery according to claim 7, wherein the one of the external lead-out members is provided for the electrode terminal, and the another of the external lead-out members is provided for a non-terminal region which is a region other than the electrode terminal in the same battery main surface.

9. The secondary battery according to claim 1, wherein the plan view outline of the electrode terminal is constituted by the single linear portion and the single curved portion.

10. The secondary battery according to claim 1, wherein a plan view opening outline of the opening of the outer case includes both a linear portion and a curved portion.

11. The secondary battery according to claim 1, wherein a plan view outline of the insulating seal member includes both a linear portion and a curved portion.

12. The secondary battery according to claim 1, wherein as electrodes of the electrode assembly, a positive electrode and a negative electrode that are capable of occluding and releasing lithium ions are provided.
